(19) United States
(12) Patent Application Publication
(10) Pub. No.: US 2021/0075364 A1
(43) Pub. Date: Mar. 11, 2021

(54) Solar module mounting apparatus with edge to edge waterproofing capabilities

(71) Applicant: John Wakeman, Ann Arbor, MI (US)

(72) Inventor: John Wakeman, Ann Arbor, MI (US)

(21) Appl. No.: 17/098,446

(22) Filed: Nov. 15, 2020

Related U.S. Application Data
(63) Continuation-in-part of application No. 16/919,105, filed on Jul. 1, 2020.
Application No. 16/919,105 is a continuation-in-part of application No. 16/132,463, filed on Sep. 16, 2018, now abandoned.

(51) Int. Cl. H02S 20/23; H02S 30/10; E04D 3/40; E04D 3/38

(52) U.S. Cl. CPC H02S 20/23; E04D 3/38; E04D 3/40; H02S 30/10

(57) ABSTRACT

An apparatus is contemplated for creating a structure which simultaneously serves as both a building element and a photovoltaic power source. Components of the invention interface with modules which comprise photovoltaic solar panels. When used collectively, these modules are contemplated as comprising a replacement for a roof or other building component. When the present invention is used, a roof or other building component can be created without the need for a separate underlayment, and without the need for tiles or another outer waterproofing layer. This setup results in power generation, cost savings, and environmental advantages Additionally, embodiments of the invention comprise fixed stop elements which ensure correct placement of modules on a frame assembly. The invention could also include other elements, including water gutters, grab steps which facilitate access, and specially positioned border covers to protect and aesthetically cover wired regions of solar modules.

The following continuation-in-part application claims the priority benefit of earlier application Ser. No. 16/919,105, filed on Jul. 1, 2020, which claims priority from earlier application Ser. No. 16/132,463, filed on Sep. 16, 2018.

### BACKGROUND OF THE INVENTION

### 1. Field of the Invention

The present invention relates to an apparatus for creating a structure which simultaneously serves as both a building element and a photovoltaic power source, known in the art as “Building Integrated Photovoltaic”, or “BIPV”.

Solar electric (photovoltaic) generation is predicted to be a much greater part of a future mix of electrical generation techniques. A key to getting solar energy generation more widely adapted is to reduce costs. In doing so, people have often struggled to get every aspect of installation costs reduced. This invention attempts to “side-step” the typical methods of reducing cost by instead eliminating many construction and maintenance costs, rather than reducing the installation cost. This invention attempts to keep the cost of BIPV in line with conventional solar installations, while offsetting the cost of redundant building cladding and structure, be they roofs or walls. Components of the invention interface with solar modules (alternatively referred to herein as “modules”) to comprise a photovoltaic solar array (hereinafter “array”). When used collectively, these components are contemplated as comprising a replacement for a roof or other weatherproof cladding. When the present invention is used, many other components of conventional building construction are not needed, such as decking, underlayment, shingles or other cladding. Some or all of these redundant components are still required with other Building Integrated Photovoltaic systems. Compared to conventional rooftop solar installations, the current invention also eliminates a need for racking components, including between shingle flashing, rails, conventional clamps, and associated hardware.

The contemplated invention results in power generation, cost savings, and environmental advantages.

Additionally, embodiments of the invention comprise a clamping mechanism which secures modules at two different heights, with a lower module being clamped through flashing. Various sizes of flashing and clamping mechanisms can be used to achieve an array with a different final dimension. Portions of a clamp assembly, in concert with vertical covers and spacers, comprise fixed stop elements which ensure correct placement of modules on a frame assembly. The invention greatly enhances the ability to provide service if a module, or electronic component mounted below it, requires replacement or repair. A particular arrangement of elements allow convenient removal of one module from any location in the array without removing other modules. Other examples of such elements include grab steps, which can be stepped on or held, thereby allowing a service technician, or safety personnel such as a firefighter, to easily maneuver along a roof or other building surface when required. These grab steps work in concert with how the solar modules collect energy, and are optimized to avoid blocking sunlight from reaching solar cells of modules, or to at least minimize shading on active areas of the modules.

### 2. Description of the Related Art

Several apparatuses are known in the art wherein photovoltaic solar panels can be mounted on top of a roof, used as a roof, or otherwise used as a building component or as an addition to a building. The comparison below focuses primarily on Building Integrated Photovoltaics rather than comparing it to more typical configurations of solar modules, such as ground mounted solar, or conventional above-roof racking.

Building Integrated PV is very unusual, about one percent of the market, as it typically costs much more than conventional solar installation techniques. There are a variety of ways in which such apparatuses are structured and designed. However, when used as a roof or other cladding, such apparatuses frequently have the disadvantage of requiring custom-built solar modules. While these other inventions might function as designed, using them is much more costly and commercially disadvantageous than would be the case with a system which could fit “off the shelf” solar modules. Such a system would take advantage of the fact that “off the shelf” solar modules have already achieved substantial manufacturing volume and economies of scale, lowering costs and increasing convenience. Hence, the present invention provides a system wherein these modules could be used as cladding. While most manufacturers specify that their modules are not “waterproof”, they often include waterproof glass which comprises most or all of their surface area. The present invention takes advantage of the glass surface area by waterproofing around it and bridging from one piece of glass to the next. Additionally, many of these pre-existing designs are not well adapted for safe, easy access when maintenance or repair is needed in an area occupied by their solar array(s). In order to provide such access, the solar array is typically kept three feet from roof edges, and is made non-contiguous every 50 feet according to one widely used building code. A typical residential roof might limit the solar array to only 54% of the area. As a result, most existing BIPV systems only have provisions to interface at their edges with conventional roofing materials (rather than going all the way to an edge of the roof). Any system which makes it difficult to install or maintain such an apparatus not only adds to labor costs, but it can be hazardous to service technicians or emergency personnel who need to work on it.

Because most BIPV existing art is made to transition to conventional roofing, they don't have features which wrap edges of the roof to transition to a conventional upper wall of a building. Instead, they rely on conventional roofing material and methods for doing so. For the same reason, spacing of the modules is not adjusted to match the building, but rather gets as close as possible according the discrete dimensions of the modules.

In some BIPV systems, if a module in a center of the array needs to be removed, modules above would need to be removed in order to remove said module. Many other systems require access to an underside of a module in order to remove and replace it. The present invention allows removal from above of one or more modules. Additionally, existing designs often lack features which allow reproducible positioning of modules. If present, these features would ensure that every module is positioned consistently and would insure that after a module is removed, a replacement module will be positioned identically. Such features could also make it possible for a single person (rather than a two-person team) to install and position the modules correctly, without needing to hold them while a clamping mechanism is secured.

As such, it could significantly save time, expense, and building materials if off-the-shelf solar modules could be used as part of a building-integrated solar cladding, and if such a system allowed for easy and efficient maintenance and repair of a finished system. A resulting roof is also likely to last longer than conventional roofing, and would never have to be removed to replace a roof below it, as is common with conventional rooftop solar installation. The contemplated invention has an additional advantage over a conventional solar array without this added cost of ownership.

### SUMMARY OF THE INVENTION

In this application, the term “off-the-shelf” module refers to a solar module of one of a number of sizes available. Features of the invention include having flexibility and adaptability, which allow it to operate with several different sizes of solar modules. Accommodating multiple manufacturers with well established distribution systems is another contribution to cost savings.

A key characteristic of the invention disclosed herein is a capability for its components to be of particular sizes and relative positions.

In this application, the terms “solar module” and “module”, are used interchangeably.

In this application, the terms “solar array” and “array” are used interchangeably, and refer to a set of solar panels on a building arranged in rows and columns.

A module will comprise solar cells in an “active area” (this is an area which can receive sunlight for conversion into electricity), and will also comprise “inactive areas.”

These “inactive areas” will not have solar cells, but might have wire leads (on an under-side of the solar modules), conductive ribbons or other electrical conductors. Module frames (present in some module designs) would also constitute inactive areas. (Modules with these characteristics are well-known in the art.) Inactive areas around the edges of the modules are not limited to these components, and are there to provide space between solar cells and edge of the module to protect the solar cells and for electrical isolation.

Much of this disclosure focuses on descriptions of the invention being used in place of a building roof; however, it will be understood that other uses in different contexts, such as walls, cladding, or other building components or structures, are also contemplated. Terms such as “up-roof” or “down-roof” can be understood to refer to an upward direction or a downward direction, even if the context in which the invention is being used is related to a different component than a building roof.

In this application, embodiments of the invention are designed to be placed on a “supporting substructure”, which could comprise rafters and/or trusses. Unlike other BIPV systems, only framing is required below.

The invention arranges solar modules in a configuration that replicates functions of a typical roof (such as waterproofing and weatherproofing). As such, using the invention allows replacement of a conventional roof with a solar module arrangement.

In general, directions identified in this application are referred to as a vertical (meaning, an up-roof or a down-roof direction), or horizontal (meaning, a direction perpendicular to an up-roof or a down-roof direction, traveling across a roof or supporting structure such as rafters or trusses). Another direction, identified in this application as “height” or “elevation”, represents a direction perpendicular (or nearly so) to the rafters or other supporting structure.

A number of drawings accompany this filing.

Specific features identified in these drawings include a height differential (where the term “height” refers to a direction roughly perpendicular to a rafter or top chord of a truss, or other uppermost roof framing member).

Other features identified comprise a clamp with an upper clamp surface adapted to press down on one component, and a lower clamp surface adapted to press on a different component. Some embodiments of the invention include an assembly where each clamp will be positioned to put pressure on an up-roof module with its upper clamp surface, and a down-roof module with its lower clamp surface. Pressure on said down-roof module might be accomplished by pressing on a waterproof membrane which is positioned atop an up-roof surface of the down-roof module. Other features could include elements which are used to create clamp pressure, such as a stanchion, adapted clamp in a downward-height direction.

### General Info

Building Integrated Photovoltaic (BIPV) from Standard Modules

BIPV only accounts for about one percent of the solar market. Every time someone tries to bring a product to market they end up failing, primarily (but not exclusively) due to the cost of “special” photovoltaic modules, and the high cost of these materials. The lowest cost of energy out of photovoltaic solar modules comes from off-the-shelf framed modules comprising glass surfaces. These are generally not used in BIPV because there is leakage between a module frame and module glass, and it's unlikely that any manufacturer will guarantee this junction area as waterproof. Therefore, the lowest cost photovoltaic (PV) is not available for use in BIPV. The energy out of these modules is obtained at the lowest cost available for photovoltaic for several reasons. Their development has evolved in the market in an organic way to result in particular module sizes, weights, and strengths. The uniformity of these few configurations has enabled the market to advance and reduce turnkey installation cost by several orders of magnitude. The current invention enables these low cost, high production modules to be used in a Building Integrated way.

Another key factor is the ability of the invention to work in concert with module dimensions from various manufacturers in order to ensure that an overall array dimension will match that of the building. Dimensions of contemplated vertical spacers and waterproofing covers, in concert with dimensions of contemplated end covers, will result in a horizontal dimension that matches the building. Dimensions of contemplated horizontal supports, flashing, and clamps, in concert with dimensions of contemplated peak components and lower eave components, will result in a vertical dimension that matches the building. Components of the invention connect outer borders of the roof with adjacent conventional surfaces of the building. (Most BIPV systems interface with conventional roofing rather than going to edges of the building and working in concert with facia, or walls, or roof peak.) Briefly described, the invention comprises apparatuses for incorporating technology into a building—such as a building roof, or such as siding on a wall of a building—which allows collection of solar energy and convenient servicing of apparatus components.

Embodiments of the invention are contemplated as providing a replacement for a building component. Specifically, these embodiments can be used in place of a roof, ft wall cladding, an overhang, or another building component, and therefore obviate the need to mount a solar array on top of an existing roof structure and cladding/weatherproofing.

In general, the following disclosure discusses situations in which the invention is implemented as a replacement for a building roof. Despite this, it should be clear that embodiments are also contemplated wherein the invention is connected to, or used in place of, other building components, e.g. walls, awnings, or overhangs.

Advantages of the present invention include minimization of costs by potentially eliminating unnecessary materials, such as roof decking, underlayment, and shingles. Materials also avoided are components that are normally used to mount solar components above a roof, such as rails, hardware, between-shingle flashing, and clamping components.

Another advantage of the present invention includes elimination of a need for an underlying roof, and hence obviation of a need to remove and re-install a solar array in order to access, maintain, repair or replace said underlying roof.

Another advantage of the present invention could include a design which can cover an entire roof, from side to side and/or peak to gutter, thereby maximizing solar exposure, improving building aesthetics, and simplifying building construction.

### Components that Support and Arrange the Modules

Another advantage of the present invention compared to many BIPV designs includes a random-access design which allows every module to be removed without being blocked by any other module.

In some embodiments, an apparatus comprises one or more horizontal joint support, which are securable to trusses, rafters, or other supports. The horizontal joint support are sized and shaped in a way which allows them to reliably interface with off-the-shelf solar modules of various sizes.

Another advantage of the present invention might include the use of spacer elements (hereinafter “spacers”) which are positioned in between modules which are next to each other in a horizontal row of a roof assembly. Such spacer elements can be adapted to assist in consistent spacing of module. The spacers work in concert with vertical joint covers, to interface with and cover designated parts of said modules. The spacers also work in concert with other components contemplated to ensure the array's overall width comes out as desired, typically to match the width of a building.

Another advantage of the present invention is that the spacers can be a part of a pre-assembled component, where all contemplated parts are installed as a unit.

Another advantage of the present invention could include a design which allows modules in one row to be offset from modules in other rows. This prevents vertical joints in adjacent horizontal rows from lining up with one another.

### Things that Secure the Modules

Another advantage of the present invention could include a clamping system which adapts to result in a different overall roof dimension.

Another advantage of the present invention is a clamp that is used for two modules at two different heights in relation to the substructure, with a lower clamping surface pressing through flashing to secure a down-roof module positioned beneath said flashing.

The horizontal joint support could have adaptations which allow clamping elements to be secured to them. These clamping elements are adapted to interface with one or more modules, and to hold one or more of said modules in place.

### Things that Waterproof

Another advantage of the present invention might include a design wherein up-roof elements on a building overlap with down-roof elements, which allows rain water to flow down a roof surface without flowing under any modules or leaking into a building. An example could be a waterproof membrane such as flashing, which is positioned underneath part of an up-roof module while also being positioned over part of a down-roof module. Another advantage of the present invention includes elimination of a need to use additional outer material, such as shingles or other outer-layer waterproofing.

Another advantage of the present invention includes elimination of holes or penetrations in an existing roof structure, which would normally be necessary to secure a roof-mounted solar apparatus but which would create a risk of leaks in the existing roof structure and would therefore require their own waterproofing or flashing.

Another advantage of the present invention could include an ability to use standard photovoltaic solar modules, rather than requiring custom modules. This is achieved by catchments above and/or under certain areas of the modules that are susceptible to water, such as where the metal frame meets the glass portion of the module. Further, use with standard modules is possible by bridging between adjacent modules, and bridging between these conventional modules at both ends of each horizontal row, and a conventional building surface adjacent and perpendicular to a roof. This functionality could be provided by particularized shaping, tapering, and/or construction of components.

Another advantage of the present invention could comprise components such as edge caps which can cover empty areas, and which can link modules with conventional building components such as a horizontal rake board or a wall. The dimensions of this component work in concert with other components to divert weather and fill space so array dimensions match desired roof dimensions.

Another advantage of the present invention could comprise components such solar flashing with a drip-edge for a down-roof edge of the roof where water will run off. The dimensions of this component work in concert with other components to divert weather and fill space so array dimensions match desired roof dimensions.

Another advantage of the present invention could comprise components such as solar peak flashing, both vented and non-vented. The dimensions of this component work in concert with other components to divert weather and fill space so array dimensions match the desired roof dimensions.

Another advantage of the present invention could include adaptations allowing frameless modules to be used.

Another advantage of the present invention includes a lack of underlayment or other obstacles. These obstacles would otherwise eliminate any possibility of attaching conventional items to solar frames, such as DC optimizers, micro-inverters, or other components. A lack of decking also allows solar cells to cool, which increases their efficiency. (Decking would also block access to a solar module assembly from below.) A design incorporating this feature could be easily and safely serviced from underneath.

Another advantage of the present invention could include specialized tapering of mounting components, allowing modules to be set at an angle relative to a substructure of a building. (A building substructure might comprise rafters and/or trusses, and would support roofing assemblies disclosed herein.) This specialized tapering could result in an apparatus which is capable of holding particular sizes of solar modules, and can also assist with setting modules in a way that optimizes waterproofing. The tapering is determined by a relative angle of the modules to a supporting substructure below (not a part of the invention). The angle of tapering is related to thickness of a down-roof module, a down-roof dimension of this module, plus an amount of spacing that is needed to achieve an overall array dimension.

It is understood that embodiments of the invention, without limitation, might include setting modules at a particular angle through other means, such as by rotating a non-tapered component to achieve this same aim.

### Grab Steps/Ladders that Make Possible More Area

Another advantage of the present invention might include the use of one or more “grab steps” which can be held or stepped on by users such as a homeowner, technician, firefighter, or other first responder, thereby facilitating movement, enhancing safety, and assisting with regulatory compliance. A further advantage of these grab steps is that they obviate the need for a separate walking area for technicians, thereby allowing an entire roof to be covered with solar modules rather than walking areas and maximizing the photovoltaic potential of a building.

Another advantage of the present invention might include features such as grab steps and/or handles, which allow a person such as a service technician or first responder to easily and safely gain access without stepping on or damaging any solar modules. These features would also render unnecessary a separate area on a roof or a person to walk in order to reach the solar modules, and thereby allow a full end-to-end design where a maximum amount of roofing surface area can be used for photovoltaic capability. For example, with most building integrated solar roofs, a module array is typically kept three feet from the edges of the roof and is made non-contiguous every 50 feet according to one widely used building code. A typical residential roof might limit the array to only 54% of its area. As a result, most existing BIPV systems only have provisions to interface at their edges with conventional roofing materials rather than going all the way to the edge of the roof.

The embodiments and descriptions disclosed in this specification are contemplated as being usable separately, and/or in combination with one another.

### Things that Support and Arrange the Modules

In some embodiments, the horizontal joint support are tapered in a way which results in an up-roof vertical measurement being shorter than a down-roof vertical measurement, which arranges horizontal rows of modules so that a bottom part of an up-roof module resting on said horizontal supporting beam is roughly the same height as a top of a down-roof horizontal row of modules (where “height” is measured perpendicular to an uppermost roof framing member, such as a rafter or other supporting substructure).

In some embodiments, the horizontal joint support comprise lower protrusions which are adapted to assist in positioning and/or support of modules, so that an entire roof assembly is raised above a supporting structure. In some embodiments, upper supporting surfaces of these lower protrusions are parallel to an upper supporting surface of a portion of the horizontal joint support that holds an up-roof module, which results in these lower protrusions having an up-roof vertical measurement which is shorter than a down-roof vertical measurement.

In some embodiments, the horizontal support beams are adapted to interface with staggered rows of modules, which are offset with respect to one or more other rows of modules, resulting in vertical joint assemblies also being horizontally offset with respect to one another.

In some embodiments, support elements are positioned to provide support for modules where clamped, so a clamped area will be in compression rather than under tension, helping to (prevent damage to and preserve structural integrity of module frames not designed to resist deflection from this level of concentrated pressure. The support helps resist bending and distortion.

In some embodiments, the horizontal joint supports are adapted to secure one or more water-tight stanchion assemblies, which are adapted to prevent a payload such as a solar module from sliding downward.

In some embodiments, the horizontal joint support have one or more stanchion assemblies integrated into them, wherein said stanchion assemblies are adapted to prevent a payload such as a solar module from sliding downward, in addition to securing the clamps.

In some embodiments, the stanchion assemblies comprise a stanchion spacer plate to assist in module positioning and water proofing.

In some embodiments, the stanchion assemblies comprise rings or blocks which fit around clamp stanchions.

### Things that Secure the Modules

Individual clamps are used to secure modules into positions where their height differential roughly equals the thickness of the up-roof module , where “height” refers to position relative to a supporting substructure, in a perpendicular direction. (In other words, a lower corner/surface of an up-roof module is positioned at a height roughly equal to an upper corner/surface of a down-roof module).

In some embodiments a clamping assembly has a central portion of a clamp which is secured to a horizontal joint support, which also supports an up-roof module. In some embodiments the horizontal joint support may also support a down-roof module). The clamping assembly has a clamp that crosses the horizontal joint assembly to bridge between the down-roof module and the up-roof module. When force is applied to the central portion of the clamp via a clamp stanchion, the force is transferred via the clamp to both the up-roof module and the down-roof module. (Note that force being transferred to the down-roof module could be achieved by pressing the clamp down onto flashing, or another waterproof membrane, which has been laid on top of the down-roof module.)

In some embodiments, one or more clamp stanchions are positioned on a horizontal joint support, wherein said clamp stanchions comprise a portion of a clamping assembly. In some embodiments, a horizontal joint support have one or more clamp stanchions integrated into them.

In some embodiments, clamp stanchions work in concert with horizontal joint support, but are not integrated with them.

In some embodiments, one or more horizontal joint support comprise attachment slots which are adapted to be securable to building elements.

### Things that Waterproof

In some embodiments, end cap assemblies are adapted to bridge inactive areas between building components and designated surfaces of modules, wherein said designated surfaces of modules are inactive, and may comprise conductive ribbon, frame, blank space, and other areas where cells are not located.

In some embodiments, said end cap assemblies can be of multiple sizes, and said end cap assemblies can be positioned in a way to alternate between wide and narrow sizes so that edges of said end cap assemblies on one side are aligned with one another to form a straight roof edge, while edges on an opposite side of said end cap assemblies on are staggered in concert with, or to match, module row offset.

In some embodiments, flashing is utilized in order to block rainwater or other weather elements.

In some embodiments, vertical joint covers are sized and positioned to cover specifically sized surfaces of off-the-shelf modules.

In some embodiments, said specifically sized surfaces of off-the-shelf modules comprise electrical conductors.

In some embodiments a vertical joint assembly is comprised of multiple components of the invention, with an upper vertical joint cover positioned over a top part of two modules and a gutter going below said two modules.

In some embodiments, said vertical joint covers have an asymmetric configuration, and extend further in one direction than an opposite direction relative to a central line between two installed modules.

In some embodiments, said vertical joint covers are one component of a vertical joint assembly.

In some embodiments, the vertical joint assembly has gutters positioned in a lower section in between two installed modules, acting as a second line of defense, to catch and divert any water and/or other weather elements that get past the vertical joint covers.

In some embodiments, said gutters are positioned to deposit water at their down-roof end on top of flashing and/or other waterproof material.

In some embodiments, horizontal joint supports comprise weatherproofing flanges and/or other weatherproofing elements.

### Things Adapted to Provide Grounding

In some embodiments, flashing is adapted to form a primary conductor for system electrical grounding and bonding, with multiple system components being bonded to it.

In some embodiments, the horizontal joint support are adapted for electrical bonding and/or grounding of apparatus components.

### Grab Steps/Ladders that Make Possible More Area

In some embodiments, features of one or more horizontal joint support allow them to be utilized with grab steps and/or handles.

In some embodiments, said features of one or more horizontal joint support comprise clamp stanchions and/or clamping elements, which are adapted to interface with grab steps and/or handles.

In some embodiments, said grab steps and/or handles are integrated with said horizontal joint support.

In some embodiments, said grab steps and/or handles are adapted to be reversibly attached.

In some embodiments, said grab steps and/or handles are adapted to be folded and/or rotated from a usable location to a resting location where no or less shade will be cast onto an active area comprising solar cells of a module.

Embodiments of the invention might include a ground path created by bonding components back to a wired connection point of horizontal flashing. Other solar racking systems use ground flashing, but don't use flashing as a return path. Electrical assemblies are made up of conductive material meant to conduct electricity, like copper in wires for example, and insulating materials meant to keep electricity only where it belongs, like glass on a solar module, or rubber or plastic insulation surrounding a wire. When there is a breach in an insulating material it is referred to as a “short circuit”, or a “short”, or a “ground fault” depending on what type of connection is made, and where in the circuit it happens. Conductive materials, like aluminum, that are not intended to conduct electricity as part of normal system operation, like an aluminum frame of a solar module, need to be “grounded” as is well known in the art. Generally any conductive material in contact with a solar module frame or wire, or in contact with another conductive material that is in contact with a solar module or frame, needs to be connected to an “earth ground”. A horizontal flashing might be adapted to have a wired connection point. A lower horizontal flashing with connection point connects to a symbol for earth ground, as might appear on a schematic diagram. An upper horizontal flashing also has connection point, but this point does not have a wired connection to earth ground. In this case, each piece of flashing has been manufactured to have the wired connection point available, but because the horizontal flashing and all of the conductive parts that contact them are adapted to be electrically bonded, as is well known in the art, only one wired connection is needed, having the advantage of not needing additional labor and materials to make additional wired connections. While other systems use flashing, and that flashing may be bonded to other major conductors for grounding purposes, said flashing is not the major return path. For example, if solar module (hereinafter “module”) in the upper left of the array were to have a ground fault, that ground current would travel through the module's frame to the horizontal flashing, which is adapted to be electrically bonded to said frame, and current would travel through clamps in contact with the faulty module, which are also bonded to the module frame, and closest to the wired connection point below. Other module frames would act as conductors, being bonded to both horizontal flashings as they and the clamps are adapted to do said bonding. When current gets to the flashing with the wired connection, the lower horizontal flashing and the wire connected to it will carry the fault current to the earth ground, as is well known in the art. Other system components outside the scope of the invention are designed to react to said faults and can react accordingly. This also keeps personnel safe as these bonded and wired fault current paths are of a lower resistance than the body of the personnel contacting them, making electricity more likely to travel through these more conductive materials than the body of the person. Note that clamping points are typically critical for good bonding as they represent a point of stable contact, but other means may be used to bond components to flashing. Other bonds may exist, and the means of bonding here do not limit the scope of this aspect of the invention.

Embodiments of the invention might include factors that result in a tapered configuration of horizontal joint supports. Note that similar features may be found in a down-roof horizontal joint support and/or a peak horizontal joint support.

Embodiments of the invention might be depicted by a side cross-sectional view of a roof, with a wooden vertical framing member taking the form of a rafter, solar module, and horizontal joint assemblies, with right-angled arrows pointing in directions parallel to, and perpendicular to, a rafter. Features of the invention might hold a solar module at a specific angle relative to a rafter. A horizontal joint support could have sides such as a top, skyward side and a bottom side, which are oriented at a particular angle relative to one another, because of the horizontal joint support having a tapered shape. A side rests on a top surface of a rafter, and therefore has the same orientation. Note that it is the angle of side to the conventional roof angle of the rafter that is critical—because of it, horizontal joint support holds solar module in a particular orientation relative to the rafter. Achieving a same or similar angle by other means is included within the invention; in other words, embodiments which hold solar module at a desired orientation and angle relative to rafter are contemplated, even if such embodiments achieve this aim with different features—such as rotating a non-tapered horizontal beam and using it to support solar module at a particular angle, rather than using a tapered horizontal joint support. Moreover, relative angles different from the specific one described are also contemplated. Note that in this embodiment, up-roof side is shorter than side down-roof side. With framed modules, the height of a module frame will be roughly equal to the height of a down-roof side (where “height” refers to a measurement perpendicular to the top surface of the rafter).

(Note: the two critical horizontal dimensions are the overall horizontal dimension of the module, and spacing between horizontal rows of modules.)

Embodiments of the invention might include a relative angle between orientations of rafter and solar module. This relative angle is crucially relevant in cases where a horizontal joint support with a specific tapered shape rests atop a roof comprising a rafter (and/or a substructure of a roof line). A dashed-line triangle might be superimposed on the assembly. One angle of this triangle, angle F, is sought by calculation. One angle of this triangle is a right-angle formed by sides J and H. Side J is roughly equal in dimension to the height of module frame (“height” measured perpendicular to a rafter). Side H is equal to the combination of length of a solar module, plus spacing to another module down-roof. The dimension of hypotenuse I is not needed here. In cases where two sides are known and the angle is sought, the inverse trigonometric function arc tangent is used. (Arc tangent of dimension J divided by side H will yield the value for angle F.) To plug in numbers for an imaginary installation of this type, we can use modules with a dimension of 39.5″ and an imaginary spacing of 1.5″ and a frame height of 1.375″. To calculate side 202h we add 39.5″ and 1.5″ spacing for a total length of 41″. If we divide the module height 1.375″ in this example by 41″ we get 0.0334. Using this value, the arc tangent results in an angle of 1.92 degrees. Therefore, in this case, a side (of horizontal joint support) is at 1.92 degrees to the substructure of the roof line. As is evident from this calculation, changing the module dimension, or spacing between rows, or module frame thickness, will result in a different angle. Spacing can change to adjust the overall roof size which makes H a variable, unlike the vast majority of BIPV solar roofs which do not allow for adjustment of spacing between modules. Because we are using a variety of off-the-shelf modules, our module dimension can change from one manufacturer to another, also different from BIPV systems where special modules are manufactured. (That is, the invention has adjustable elements which allow it to be used with various sizes of solar modules. By contrast, a typical BIPV system requires modules of specific sizes to be specially manufactured to fit the system.) An even greater difference is realized when a roof is made up of modules in “portrait mode” (with modules oriented so that their up-and-down-roof dimensions are larger than their horizontal, across-roof dimensions) rather than “landscape mode”. In the case of portrait mode, a long dimension of the module goes in a vertical direction, meaning up- and down-roof. In the example above, the dimension of 39.5 inches would instead be on the order of 66 or 79 inches. The conceived invention accommodates many options for roof size, and many sizes of off-the-shelf solar modules. (Module thickness can vary greatly from one manufacturer to another, for instance.) By contrast, typical building integrated systems with custom modules don't possess any flexibility to vary overall roof dimensions (other than adding or subtracting a row or column of modules, and making up the difference with by using conventional roofing surrounding the solar array).

Also for instance, a user might prefer frameless modules instead of framed ones. A frameless module, whose thickness is determined by just two layers of glass without a frame, results in a different angle and the formula results in a very different angle.

Embodiments of the invention might include solar roofs which include climbing apparatuses. Embodiments of the invention might include three clamp rung assemblies installed on a left-most column of solar modules. Embodiments of the invention might include clamp ladder, installed on a left-most column of solar modules. Embodiments of the invention might include a clamp rung-block bolted onto clamps. In some embodiments, rungs are a portion of a rung assembly which would be used to grab with hands and stand on with feet in order to climb the solar roof. In some embodiments, a ladder clamp block is bolted onto clamps. In some embodiments, rungs are a portion of the clamp ladder which would be used to grab with hands and stand on with feet in order to climb the solar roof. Unlike the clamp rung assembly, the clamp ladder provides additional rungs between the horizontal joint assemblies. In order to do so, a ladder side rail is suspended on top of and attached to a ladder clamp block. In this species, ladder rung could be attached to and supported by a ladder side rail. Ladder clamp blocks at horizontal joint locations are attached to and supported by clamps. In this species the clamp ladder is supported by clamps, but this does not limit the invention. In other embodiments, attaching clamp ladder more directly to other components such as a horizontal joint assembly might be contemplated. Also, in some embodiments both the clamp ladder and clamp rung assembly are directly over a single column of solar modules; however, alternate embodiments are also contemplated which might include clamp ladders or clamp rung assemblies of different sizes, and/or secured in different positions using different clamps on a roof. One example might include a horizontally smaller clamp ladder, attached to clamps adjacent to borders of solar modules, and/or adjacent to vertical joint assemblies, and therefore positioned over said borders and vertical joint assemblies. (Smaller horizontal dimensions would require less material to achieve the same strength of a given rung.)

Embodiments of the invention might include a clamp rung assembly. In some embodiments, a clamp rung-block is bolted to a clamp. A socket-head cap screw is put through countersunk clearance holes. Male threads of the socket-head cap screw mate with female threads in order to support and attach the clamp rung assembly to the roof. In some embodiments, the clamp rung assembly is associated with a rung as a round rod coming through a top part of a clamp rung-block and is attached to it via a weld ring.

Embodiments of the invention might include a climbing apparatus that does not use rungs to support the climber, but rather clamp grab-step assemblies for a single hand or foot rather than multiple appendages. Embodiments might include a possible configuration for grab step assemblies, attached to clamps on a roof in two vertical rows. Embodiments might include a grab step attached to a grab-step block with a pivot pin. In this species, the grab step is able to adapt to different roof angles, or to be stored at a different angle if this is advantageous for solar access when not being used (otherwise, it may cast a shadow on modules). To change orientation of the grab step, a locating pin handle would be grabbed in order to remove a pin portion from a hole in the grab-step block. With the locating pin removed, the grab step can be rotated around an axis formed by a pivot pin until a clearance hole is aligned with a selected hole in the grab-step block. Locating pin is put through clearance hole and into the selected hole in grab-step block, thereby holding the grab-step at a different angle. While two rotational positions are possible options, other methods of securing, rotating, and positioning widely known in the art are also contemplated.

Some assemblies can be broken into sections that can be built from the bottom up, top down, or from the end of the roof inward. This will enhance usefulness in cases where said assemblies are not a permanent installation at a given site. For service in a multi-story building, a technician could install a lower section from a standard ladder, then stand on this section to install another section, and work their way up the roof to a desired height or horizontal row required to best perform the services needed.

Note that attachment by any method widely known in the arts is included here. Clamp could have any number of adaptations to accept and secure any portion of the climbing apparatus conceptualized, as could other locations or instances of horizontal joint assembly, vertical joint assembly, as well as adaptations on end cap assemblies. Peak assembly and down-roof horizontal assembly could also have any number of adaptations to support and secure a climbing apparatus. Embodiments can be all rigid assemblies, but adaptations are conceptualized where the assemblies can be folded up or down, either to enhance climbing ease for a given situation, or for storage.

While it doesn't matter for temporary service installations of any of the climbing apparatuses, those that may be permanently installed may be constructed of reflective material, have separate reflectors mounted to them, or be made in a geometry to help mitigate losses of energy production due to shading of an active area of solar modules in proximity to the climbing apparatus. Note that these components can change based on geographic location of installation, where weather patterns and angle of incidence to the sun can be taken into consideration, as well as slope of the solar roof.

Grab steps or handles can function as steps, footholds and/or handholds when a homeowner, technician, firefighter, first responder, or other person needs to move from place to place on a roof assembly. Note also that embodiments are contemplated where grab steps or handles can be reversibly attached to other roof assembly components. Note that rotating is possible, but twisting on a different axis or other methods of folding are also contemplated. Rotational and/or folding functionality of a grab step or handle can be useful for a number of reasons, such as conveniently placing them out of the way into a configuration which does not block sunlight from reaching solar cells of roof modules.

### BRIEF DESCRIPTION OF THE DRAWINGS

FIG. 1 shows an example embodiment of the invention as a roof assembly installed on a building.

FIG. 2 shows two roofs, both a three-by-three array. The roof shown in the lower drawing has larger horizontal and vertical spacing, to result in a larger roof.

FIG. 3A shows a three-by-three roof array with a cross section of a lower row of modules. Major vertical assemblies of the cross section are shown (in inset views).

FIG. 3B shows details of large end cap assemblies which cover a left end of a lower horizontal row of solar modules. The lower drawing illustrates a larger version of the end cap assembly.

FIG. 3C shows details of small end cap assemblies which cover right ends of said lower horizontal row. The drawing at the bottom shows all of the components, while the one above is a wider version, used on slightly larger roofs.

FIG. 3D shows two sample cross sections of vertical joint assemblies. The upper drawing includes areas of intersection with solar modules, while they have been removed from the lower drawing. The lower drawing has the same functional parts as the upper drawing, but they are wider to expand the roof to a bigger dimension.

FIGS. 3E and 3F are the same as FIG. 3D, but show frameless rather than framed solar modules meeting a vertical joint assembly.

FIG. 3G shows a below-module water catchment system. In this illustration, glass portions of solar modules have been removed to teach how a below-module layer of the invention extends beyond an entire width of a frame of a typical framed “off the shelf solar module”, and how these components interlace.

FIG. 4A shows a typical “off-the-shelf” solar module, outside of the scope of this invention, with callouts for major functional areas of the module.

FIG. 4B shows installation order for some major subassemblies.

FIGS. 5A-5G show a progression of component installation relating to a roof assembly.

FIGS. 5H and 5I show a lower left corner of the roof assembly shown in FIGS. 5A-5G.

FIG. 5J shows an expanded view in a middle part of a roof array.

FIG. 6A shows locations of major horizontal assemblies (horizontal in installation, rotated 90 degrees counterclockwise on this page) and how they relate to a cross section shown at the bottom of the sheet.

FIG. 6B shows a cross section of a down-roof horizontal assembly and a detail view of components.

FIG. 6C shows a cross section diagram of a down-roof horizontal assembly, positioned at a bottom edge of a roof.

FIG. 6D shows a portion of a peak assembly in cross section.

FIG. 6E shows a ground path created by bonding components back to a wired connection point of horizontal flashing.

FIG. 6F shows a cross-sectional area which depicts various grounding-related components and adaptations.

FIG. 6G shows a horizontal joint assembly in side cross-section that is adapted to work with frameless modules rather than framed modules.

FIG. 6H shows a side cross-sectional view of an alternative embodiment of the horizontal joint assembly with an alternative support for an up-roof edge of a solar module.

FIG. 6I shows an alternative embodiment design where functions of the horizontal flashing and the horizontal joint support are combined into a single part.

FIG. 6J-6K show additional views of the alternative embodiment from FIG. 6I.

FIG. 6L-6M show side and front views of horizontal joint supports with specially sized and tapered sections of apparatus components.

FIGS. 7A and 7B show a portion of a horizontal joint assembly that makes up a stanchion, as assembled and expanded.

FIGS. 8A and 8B illustrate factors that result in a tapered configuration of horizontal joint supports.

FIG. 9A shows two perspective drawings of two solar roofs which include climbing apparatuses.

FIG. 9B shows expanded views of one embodiment of a clamp rung assembly.

FIG. 9C illustrates a climbing apparatus that does not use rungs to support the climber, but rather clamp grab-step assemblies for a single hand or foot rather than multiple appendages.

### DETAILED DESCRIPTION OF THE INVENTION

The following detailed description of the invention refers to the accompanying figures. The description and drawings do not limit the invention; they are meant only to be illustrative of example embodiments. Other embodiments are also contemplated without departing from the spirit and scope of the invention. Referring now to the drawings, embodiments of the invention are shown and disclosed. In this disclosure, the terms “solar panel” and “solar module” are interchangeable. In this disclosure, the terms “up-roof” and “down-roof” will be used to describe relative positions of components. For example, a solar module which is positioned further up a roof than a clamp will be referred to as an “up-roof module”, and a solar module positioned further down a roof than that same clamp will be referred to as a “down-roof module”.

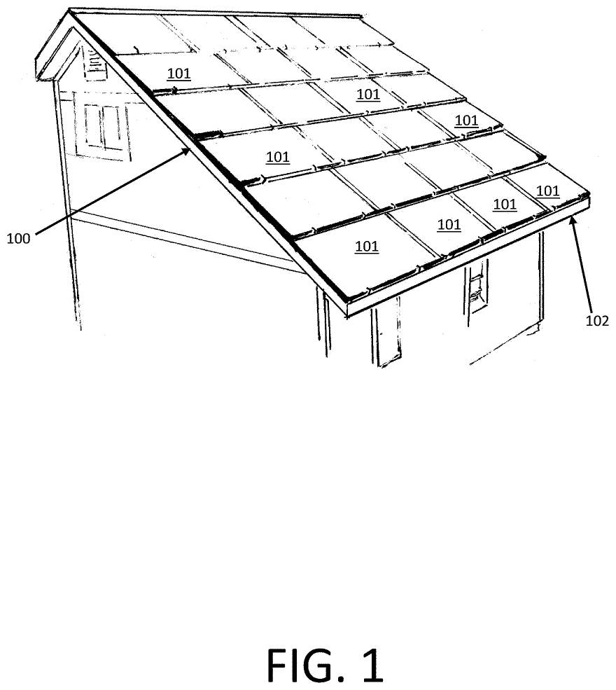

FIG. 1 shows an example embodiment of the invention in the form of a roof assembly, which comprises horizontal joint assemblies, vertical joint assemblies, peak assembly, down-roof horizontal assembly, end cap assemblies, and end covers, all of which surround solar modules 101 (not a part of the invention). The peak assembly, down-roof horizontal assembly, and end cap assemblies all work in concert with other components of a conventional building, including rake 100 and facia 102. Horizontal joint assemblies and clamps which operate together to hold solar modules in place on a building are also visible. Components outside the scope of the invention but working in concert with it include solar modules 101, which comprise frames and solar-powered photovoltaic surfaces, and are adapted to convert solar energy into electricity. Note that in this embodiment, the solar modules 101 are oriented so that they are wider horizontally than vertically (“landscape orientation”); however, embodiments are also contemplated wherein solar modules can be oriented so that the long dimension is vertical while the shorter dimension is horizontal (“portrait orientation”). Note that all components numbered in the 100 range are outside of the scope of the invention.

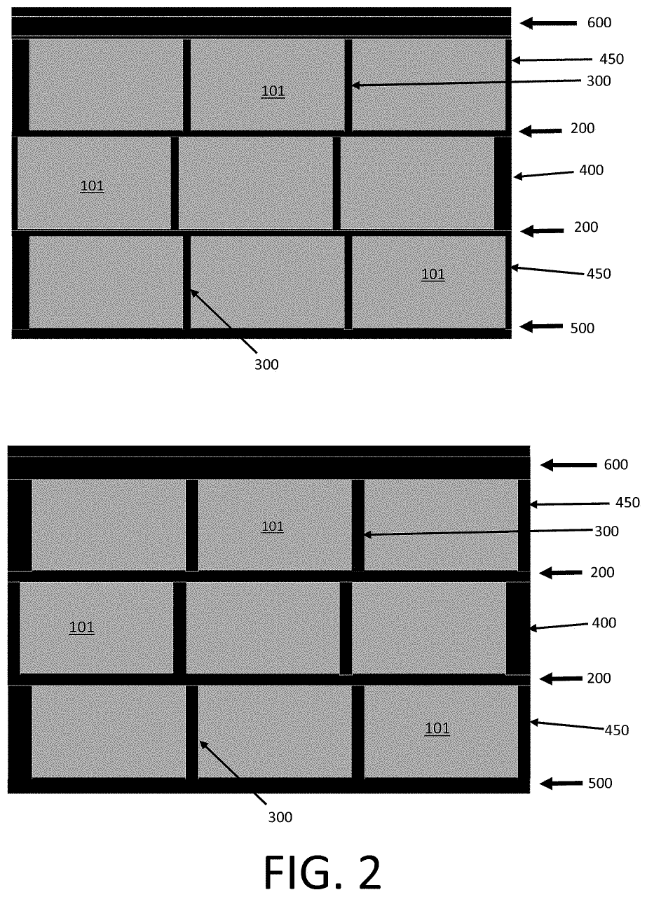

FIG. 2 includes an upper and a lower drawing which identify various major assemblies that comprise the invention. In the upper drawing, various assemblies of the invention are made to a smaller dimension than counterparts in the lower drawing. Meanwhile, solar modules 101 remain the same size in both drawings. The result is a roof in the lower drawing with a larger overall dimension, both vertically and horizontally, than the roof in the upper drawing. Major assemblies identified include horizontal joint assembly 200, vertical joint assembly 300, large end cap assembly 400, small end cap assembly 450, down roof horizontal assembly 500, and peak assembly 600.

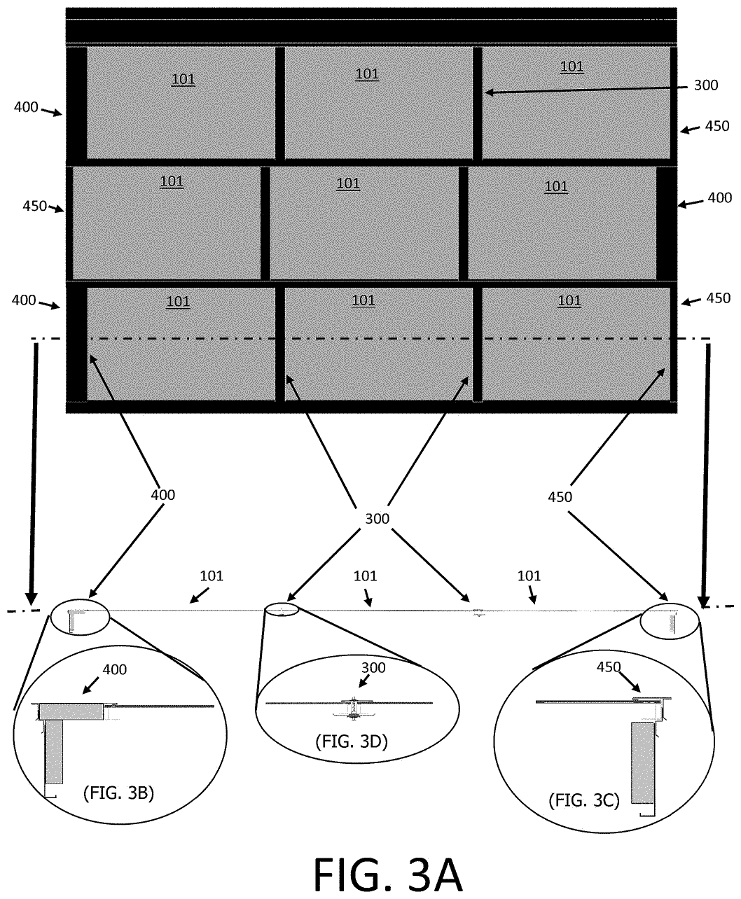

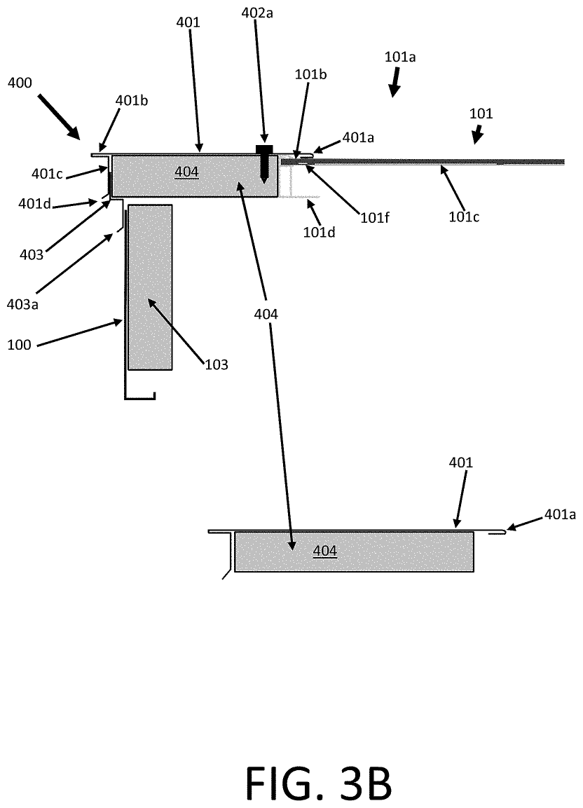

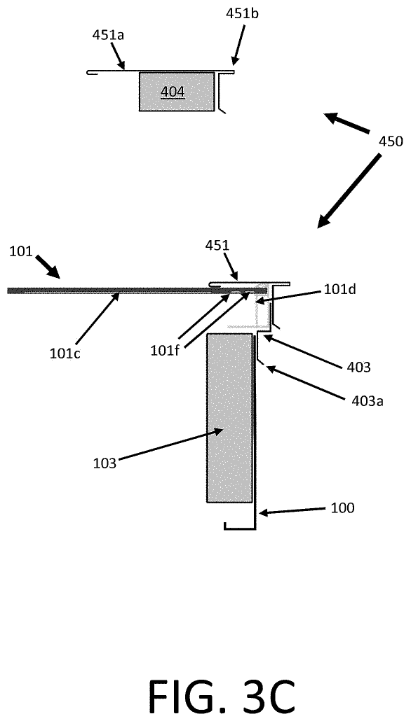

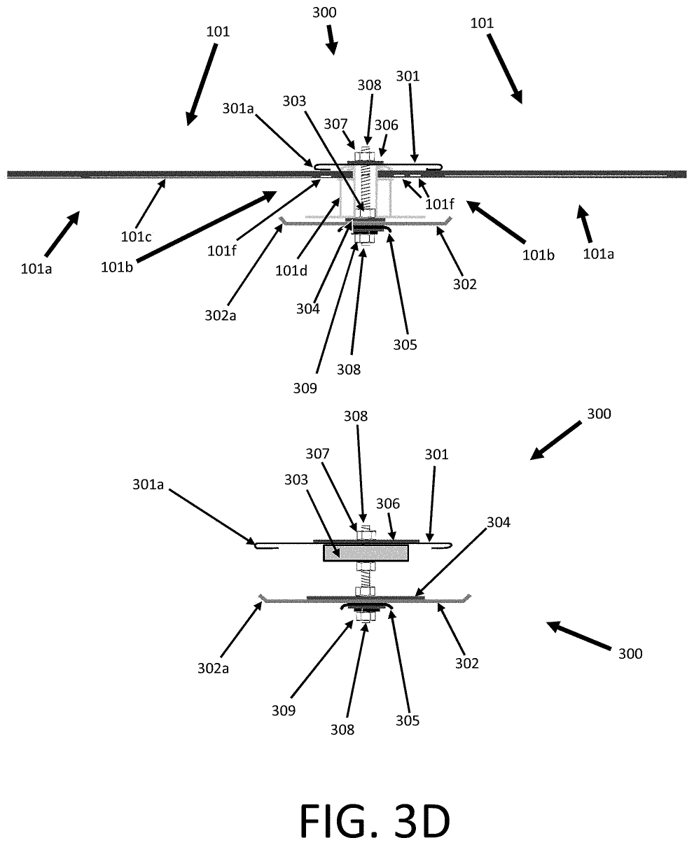

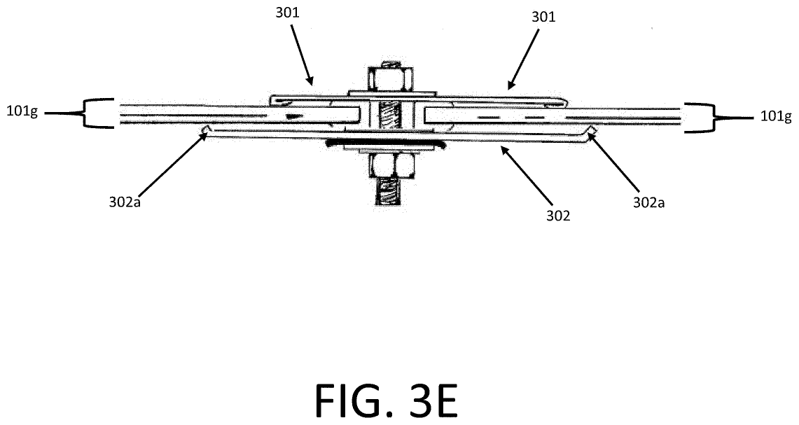

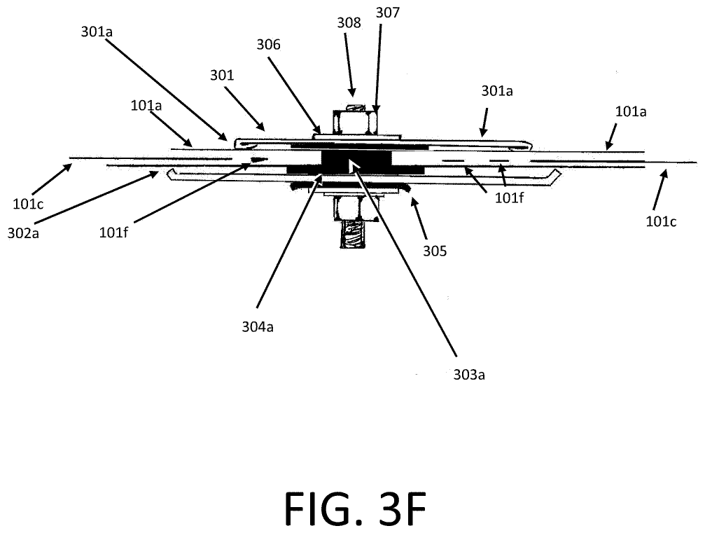

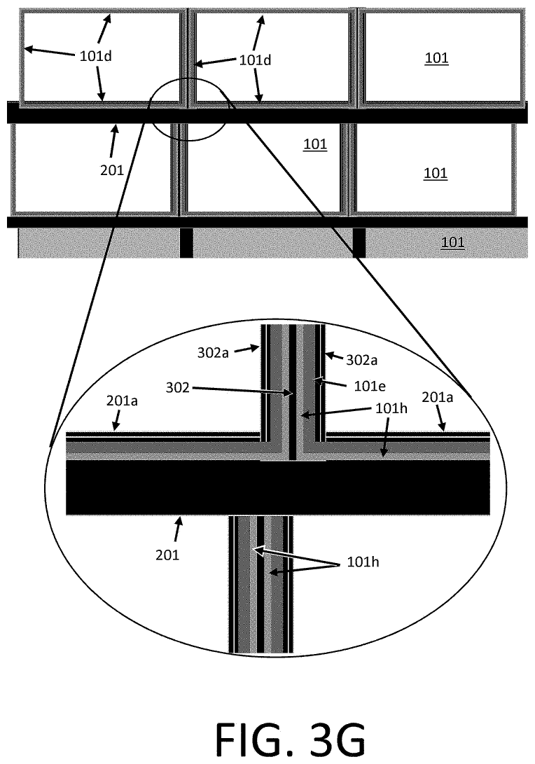

FIG. 3A shows a three by three solar array which forms a roof, comprising three rows of three solar modules 101 each—a bottom row, a top row, and a middle row. A dashed line across the bottom row of modules indicates a cross section, which can be seen in a bottom section of this figure (and which is also viewable in more detail in FIGS. 3B, 3C and 3D). For the bottom row and the top row, an end cap assembly 400 on a left side is larger than an end cap assembly 450 on a right side. (The end cap assembly 450 on the right side is the smaller of the two, since the modules 101 in that horizontal row are offset to the right in relation to the middle row immediately above.) In rows where modules 101 are offset further right, a larger end cap assembly 400 and cover are used on each row's left side while a smaller end cap assembly 450 and cover are used on its right side; in rows where modules 101 are offset further left, a larger end cap assembly 400 is used on each row's right side while a smaller end cap assembly 450 is used on its left. Vertical joint assemblies 300 are positioned in between solar modules 101, and are staggered relative to each other due to alternating offsets created by end cap assemblies as discussed above.

FIG. 3B shows the large end cap assembly 400 from FIG. 3A, expanded further to illustrate details of its interaction with building components and solar modules. (Here, large end cap assembly 400 comprises a cover, and this cover is hereinafter designated as large end cap 401.) Large end cap 401 extends above module 101, covers vertical structural filler 404 and extends beyond it, forming an edge of a roof at upper drip edge 401b. Large end cap 401 is further comprised of an upper drip edge 401b, and lower drip flange 401d. Stitch 401a is where sheet metal is folded over on itself to strengthen and create a straight smooth edge, as is well known in the art. Edge filler plate 403 exists in all edge filler assemblies. Edge filler plate 403 is shown with its upper portion slipped under a lower side of large end cap 401 near lower drip flange 401d. Edge filler plate 403 extends downward to cover rake 100. Water flowing off the roof can drip off any flange, or run down sides of the building, without contacting rake board 103 (not a part of the invention) or vertical structural filler 404. A lower part of this drawing shows an alternate, larger size of vertical structural filler 404 and a corresponding larger end cap 401. The only difference in each is the horizontal dimensions. In cases where a larger roof is desired, 401 and 404 can be made with larger horizontal dimensions to extend overall size of the roof so that this building-integrated roof matches a building's size, without conventional roofing on a roof surface installed to do so. Upper fastener 402a secures large end cap 401 to vertical structural filler 404. Large end cap 401 as shown is a sheet metal cover with stitch 401a covering inactive portion 101b of the solar module 101. Large end cap 401 extends to the roof's edge at upper drip edge 401b, and wraps down around a side of the building at vertical portion 401c, with lower flange 401d to divert water away from building components below, as is well known in the art. A top part of edge filler plate 403 slips under lower drip flange 401d at its bottom. It is possible to combine large end cap 401 and edge filler plate 403 into a single piece. If so, a vertical surface of edge filler plate 403 has to be tapered as per an angle at which solar module 101 has been positioned. With large end cap 401 and edge filler plate 403 as two separate pieces, though, this angle is easier to achieve.

FIG. 3C has two drawings showing smaller end cap assembly 450. Smaller end cap assembly 450 is very similar to larger end cap assembly 400, but has a smaller horizontal dimension. (The smaller end cap assembly 450 comprises a cover, and this cover is hereinafter designated as small end cap 451.) Assemblies 400 and 450 together, having different horizontal dimensions, arrange horizontal row of modules 101 to be offset from horizontal rows of modules 101 above and/or below. This offset ensures that vertical joint assemblies 300 do not line up one with another (in cases where that is desirable). Small end cap assembly 450 is smaller than large end cap assembly 400, and is also constructed or adapted to cover an opposite end of the roof. Depending on overall roof dimensions sought, vertical structural filler 404 may or may not be used. (The cross sections on this sheet show both of those options.) In cases where vertical structural filler 404 is used, it will likely be of a smaller horizontal dimension than another vertical structural filler 404 an opposite end of the row of modules, in order to achieve proper vertical joint offset from one row to another. (See FIG. 3B for examples of an opposite end of a row with differently-sized vertical structural fillers 404.) Note that in one row, large end cap assembly 400 will be on a left side with small end cap assembly 450 on a right side, and on an adjacent row, large end cap assembly 400 will be on the right with small end cap assembly 450 on the left. Also note that edge filler plate 403 does not change form when used on either the small end cap assembly 450 or the large end cap assembly 400, so the number for it remains the same. The horizontal dimension of small end cap assembly 450 and vertical structural filler 404 work in concert with horizontal dimensions of solar modules 101 and spacer 303 (shown in later FIG. 3D) to achieve an overall horizontal roof dimension sought.

FIG. 3D shows expanded cross sections of vertical joint assembly 300, whose location is given in FIG. 2 and FIG. 3A. The upper illustration on this sheet shows vertical assembly 300 with a partial cross section of two solar modules 101 on a left and right side, as they would be installed in a roof. The lower drawing shows vertical joint assembly 300 without solar modules 101, and with an alternate spacer 303. Shown in this view is skyward parts vertical joint cover 301. Upper clamping nut 307 above upper clamping washer 306 is also shown. Lower clamping washer 304 ensures that clamping pressure from nut 309 is directed onto frames 101d of module assemblies 101. Clamping assembly components comprise upper clamping nut 307, upper clamping washer 306, threaded rod 308, lower clamping nut 309 and lower clamping washer 304, which all work in concert to secure a central portion of vertical joint assembly 300 to adjacent module frames 101d, shown in this cross section to the left and right of this assembly. Vertical spacer 303, shown as a nut on the threaded rod in the upper drawing and as a larger spacer in the lower drawing, helps determine a horizontal dimension of the overall roof assembly (by determining how closely modules can be positioned together horizontally). As module spacing changes, so do horizontal dimensions of vertical joint cover 301, and size and strength of lower clamping washer 304 and upper clamping washer 306. Note that while the names of 306 and 304 include the word “washer” for simplicity, it is understood that they may take forms different than that of a traditional “washer,” in order to better achieve a function of providing strength for clamping and securing of this assembly, and ensuring that vertical joint cover 301 is not distorted or stretched. Several components with the same number denoting functional parts are wider in the lower drawing than on the upper drawing. Components below modules 101 include gutter 302, which extends beyond lower flanges of module frame 101d. Any fluid that were to get through vertical joint cover 301 and drip down into the building would be caught by gutter 302 and roll harmlessly down onto a lower waterproofing component of the invention described in later illustrations. Gutter 302 is formed with upward flanges 302a to contain this fluid on an upper surface of the gutter 302. Also shown in this figure is rubber gutter washer 305, used to seal a penetration which threaded rod 308 makes as it passes through gutter 302. In this illustration, vertical joint cover 301 is shown as sheet metal that has been bent to form the cover's shape. Stitches 301a provide a smooth straight edge and stiffen the vertical joint cover 301. Note that the vertical joint cover 301 extends over inactive area 101b of the solar module 101 but provides minimal or no cover of active area 101a. Water flows down a top side of vertical joint cover 301 and an adjacent glass area of module 101, thus it is prevented from entering the building.

FIG. 3E (and FIG. 3F below) shows vertical joint assembly 300 with an equivalent function and many equivalent parts as FIG. 3D, but adapted for frameless module 101g. This module does not have a frame 101d as shown in many other figures. With framed modules (not shown in this figure), as shown in the upper drawing of FIG. 3D, gutter 302 is shown to extend beyond a bottom flange of frame 101d. In this figure, though, with a no-frame module 101g, gutter 302 may have a gap between a bottom part of the frameless module 101g, or may be in contact with said frameless module 101g at upward flange 302a.

FIG. 3F shows vertical joint assembly 300, adapted for frameless module 101g (as seen here and in FIG. 3E). This figure shows an alternative embodiment of vertical spacer 303a made of a softer material or combination of materials that will act as a stop (as with all other vertical spacers), but be soft enough on contact to not damage a glass edge of frameless module 101g. (The same holds for soft lower clamping washer 304a when compared to a more rigid lower clamping washer 304, shown in drawings such as FIG. 3D of vertical joint assembly 300 adapted for framed modules. These drawings also may have callouts for solar module components 101a through 101f.) Just as in FIG. 3D, vertical joint cover 301 is sized to precisely cover differently sized inactive areas 101b on a left side and a right side, and gutter upward flanges 302a assist border gutter 450 with its task of channeling away water or other weather elements.

FIG. 3G shows a below-module water catchment system. In this illustration, glass portions of the solar modules and the vertical joint cover 301 shown in other drawings have been removed to teach how the below-module layer of the invention is comprised. Major components of the contemplated invention interacting here include gutter 302 of vertical joint assembly 300. In an exploded portion of the illustration it can be seen that gutter 302 is below a vertical side of module frames 101 beyond an entire width of two adjacent module flanges. If water were to get between this vertical portion of module frames 101d it would land on a flat portion of gutter 302 and be contained on said flat portion by upward flanges 302a. (Note that these components are shown in cross section in FIG. 3D). Said water would run down gutter 302 to its lower end, which is placed on top of horizontal flashing 201 (shown in other figures). Upward flanges 302a of the vertical gutter form a right angle to a similarly upturned catchment flange 201a of horizontal flashing 201 (shown in other figures) along its entire up-roof edge. Any fluid that has gotten onto the horizontal flashing 201 in that portion up roof of the horizontal portion of module frame 101d resting on it would either drip out of this area through gaps left, or simply rest there until later evaporated. Note that the event of water getting into this system is unusual, as the vertical joint cover 301 (shown elsewhere) keeps most or all of the water out for typical weather events. This system under the modules is a second line of defense against infiltration, and will only ever see small amounts of moisture.

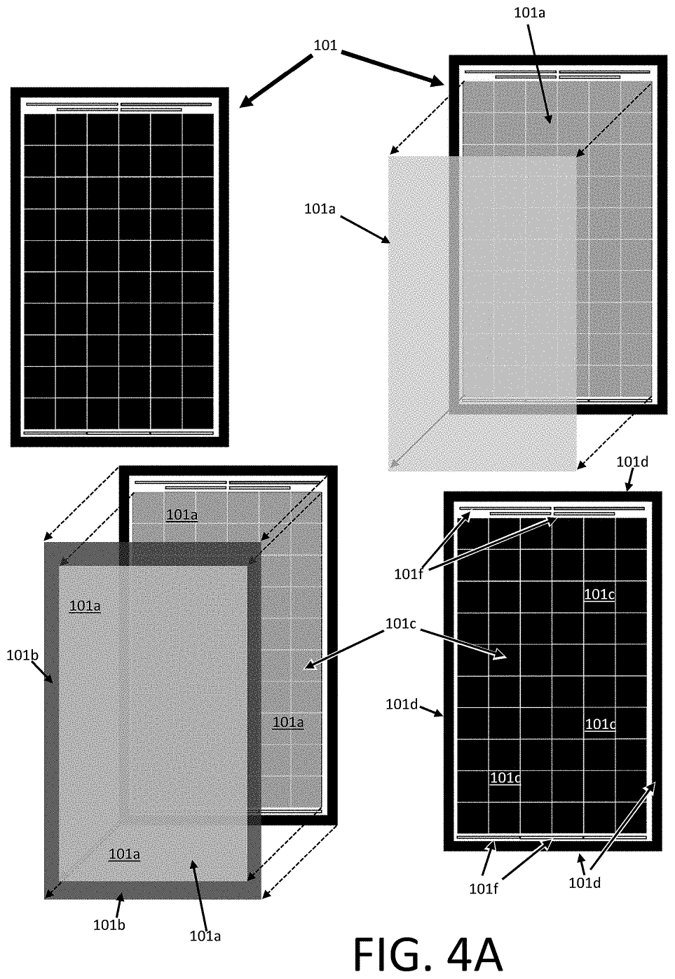

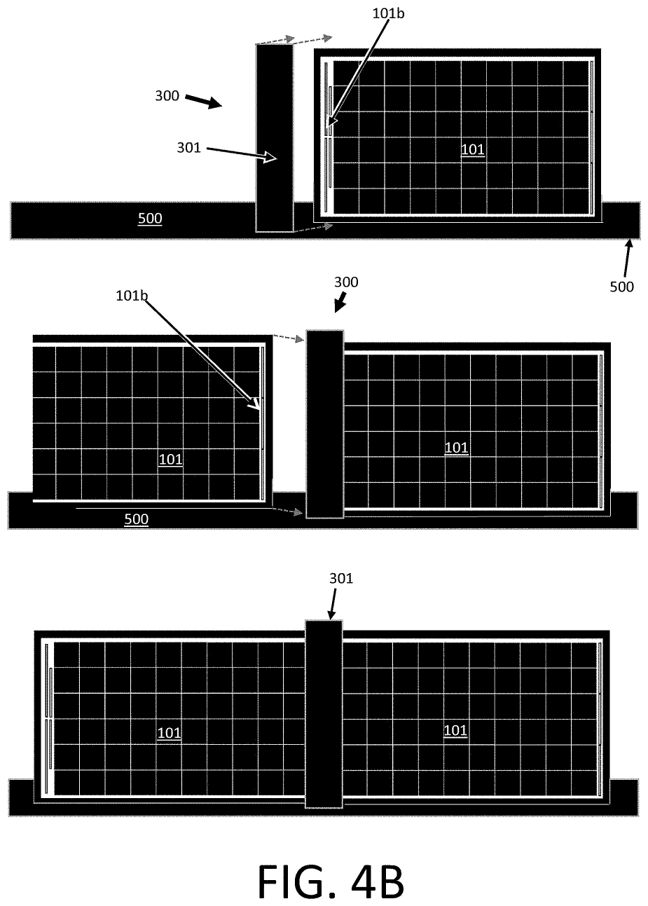

FIG. 4A shows an off-the-shelf solar module 101 (hereinafter “module) and depicts important components that comprise it. A skyward portion of the solar module 101 is shown in the upper left corner. Small squares covering most of the module are solar cells 101c, labeled in the lower right-hand drawing. These solar cells 101c are an energy generating component of the module, so the entire area they take up is considered an “active area” 101a (represented as a light gray rectangle in the upper right drawing). The drawing in the lower left of the sheet shows active area 101a of the module, and inactive area 101b which does not convert energy. In the drawing in the lower left of this sheet, inactive area 101b is shown as a darker gray rectangle bounded by dimensions equal to the outside dimensions of solar module 101 and the dimensions of active area 101a in a central area. This illustrates that outer edges of solar module 101 are inactive, while a central portion is the active area. This is critical to the invention, since many assemblies disclosed herein will cover the inactive area 101b for weather resistance without obstructing the active area 101a. The inactive area 101b contains conductive ribbons 101f at both ends of the solar module 101, which gather electricity generated by the cells and transmit electric current to wires (not shown in this illustration) leaving and extending from a back portion of the module. Module frame 101d surrounds the solar module 101 on all four sides and adds structural integrity, and provides a robust area to clamp onto rather than clamping on a glass sheet that covers the module. Note that some modules do not have a frame as shown here, and are referred to as “frameless” in this document. “Glass on glass” is another term used in the art, because frameless modules often contain their cells between two layers of glass rather than a single layer on only the skyward side, as is typical in framed modules. Note that the entire assembly shown in FIG. 4A depicts off-the-shelf parts that are beyond the scope of the contemplated invention, which work in concert with the construction of these solar modules 101, which vary from one manufacturer and model of module to another. Note also that the dimensions, and even the presence of all of these components and characteristics described, vary from one manufacturer to another, so that the invention components disclosed here must work in concert with said variables.

FIG. 4B shows a typical installation procedure for a roof assembly. Just as shingles and tiles are normally installed from bottom to top, this is also the preferred method for assembling the roof assembly contemplated. The three illustrations on this sheet show a preferred order of installation from the top-most drawing downward. The illustration at the top of the figure shows a single solar module 101 (hereinafter “module”) resting on top of down-roof horizontal assembly 500. Note that an up-roof edge of the module would also be supported, but that is omitted from the drawing. Vertical joint assembly 300 is ready to slide into place adjacent to the solar module 101 shown. (Here, vertical joint cover 301a was installed as part of a pre-assembled unit, namely vertical joint assembly 300.) As is shown in FIG. 3D above, the gutter portion 302 would go below the module, while vertical joint cover 301 will be above the module and cover inactive module area 101b. The drawing in the middle of this sheet shows vertical joint assembly 300 in position with relation to a module 101 on the right of the drawing, while another module 101 on the left of the drawing is ready to be slid in place next to vertical assembly 300. In the lower drawing, the two solar modules 101 are in position next to one another with vertical joint assembly 300 in position between them. Note that after final positioning of modules 101 and vertical joint assembly 300, inactive areas 101b are covered by vertical joint cover 301 (shown in other figures). Not shown here is spacer 303 which is covered by vertical joint cover 301 in this view. This spacer, being a part of vertical joint assembly 300, would determine relative spacing of the two solar modules 101, and ensure alignment of vertical joint cover 301 with solar modules 101.

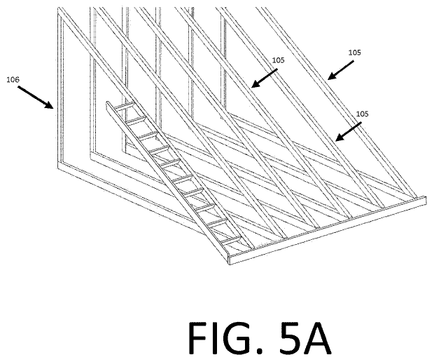

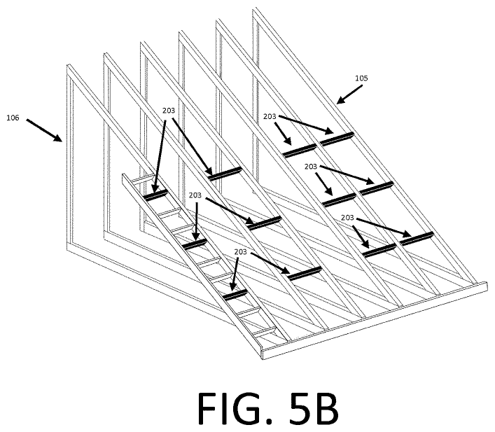

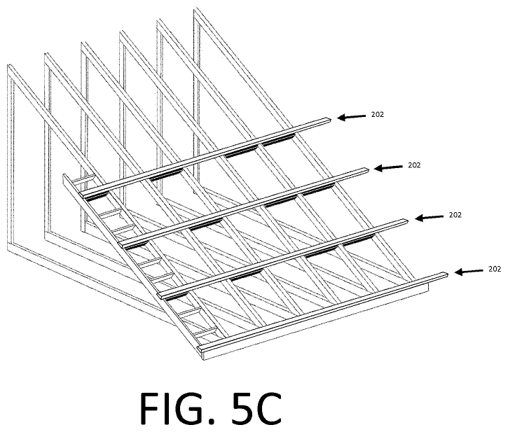

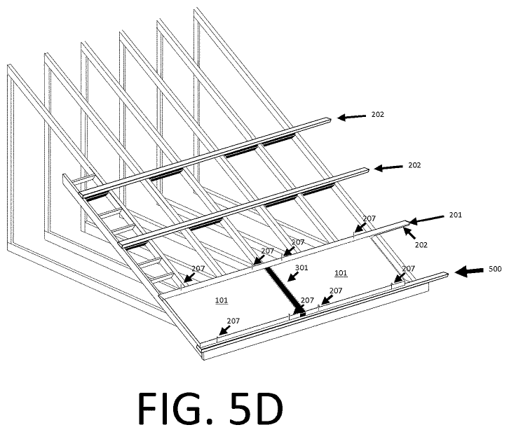

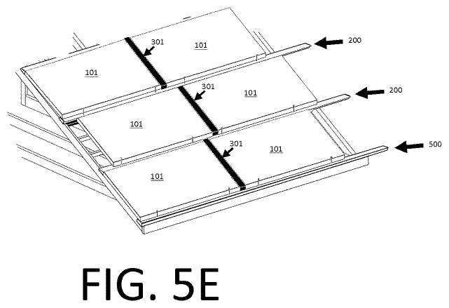

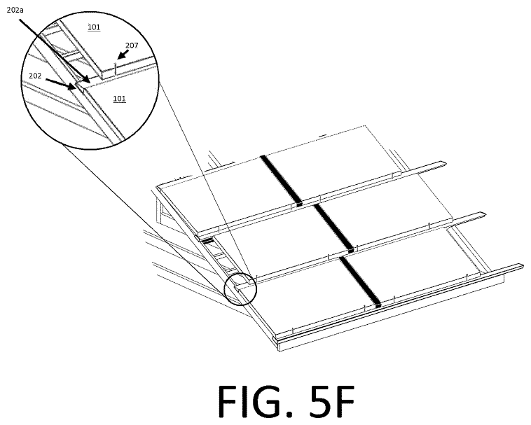

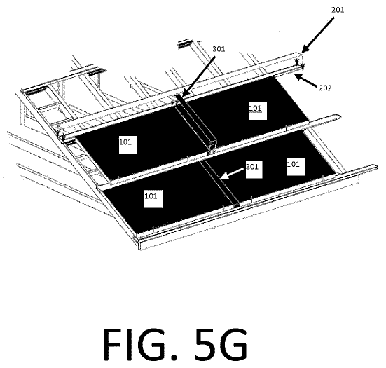

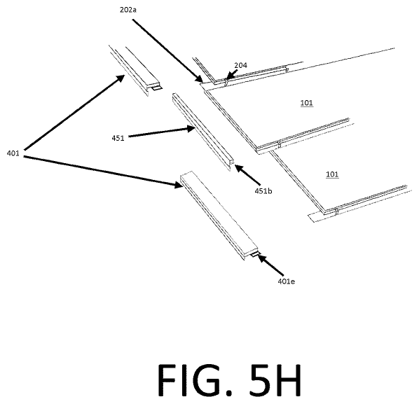

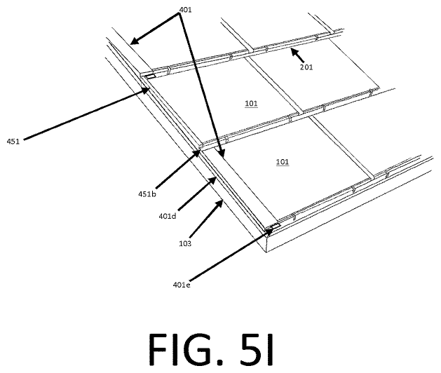

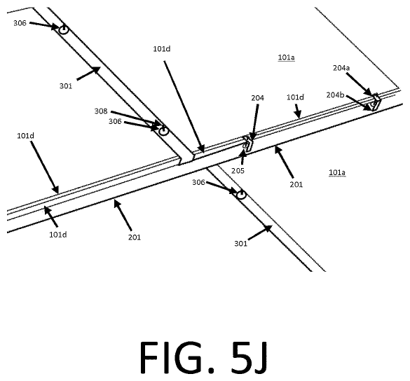

FIGS. 5A-5I illustrate alternative methods of assembling the contemplated roof assembly, with more components shown in detail.

FIG. 5A shows a conventional roof-supporting structure, before solar modules or a roof assembly are placed on it. Visible here are trusses which comprise vertical elements 106 and rafters 105.

FIG. 5B shows the structure from FIG. 5A with module up-roof support 203 added to it. The module up-roof supports 203 are used to support metal frames of solar modules 101 from FIG. 1A, in embodiments where metal-framed modules are used. (Note that frameless solar modules are also contemplated, and are disclosed elsewhere in this application.) The module up-roof supports 203 act to help prevent metallic frames, such as those of down-roof modules, from bending when the metallic frames are compressed by clamp components of the invention.

FIG. 5C shows the structure from FIG. 5B with horizontal supporting beams 202 added, in addition to module up-roof supports 203 which were added earlier. Note that these components can be secured to rafters 105 and each other by using means known in the area of building construction, such as nails or screws.

FIG. 5D shows the structure from FIG. 5C with two solar modules 101 and a vertical joint cover 301 added, as well as horizontal flashing 201 which has been placed over one of the horizontal supporting beams 202 and a row of solar modules 101. Also appearing in this view are two rows of clamp posts 207. One possible function of clamp posts 207 is to block each module from sliding down a roof during installation. Because clamp posts 207 can hold or block a module, a technician can easily place each module at or near its eventual location before installing clamps to secure the modules.

FIG. 5E shows the structure from FIG. 5D with an additional four solar modules 101 installed, making six altogether.

FIG. 5F shows a detail view of the structure from FIG. 5E. Note in this view that horizontal joint support 202 is tapered to make an up-roof side of horizontal joint support 202 vertically shorter than a down-roof side. This design helps set an angle of each solar module 101 which rests atop a top side 202a of horizontal joint support 202, facilitating eventual overlap and waterproofing as will be disclosed in subsequent figures.

FIG. 5G shows the roof assembly as two components are being added to it, a vertical joint cover 301 and horizontal flashing 201 covering an upper portion of vertical joint cover 301. Note that in some other illustrations, vertical joint cover 301 was installed as part of a pre-assembled unit. This illustration, though, shows the design has been adapted to allow vertical joint cover 301 to be independently added or removed.

FIG. 5H shows a roof assembly to which end caps can be attached. In this view, small end cap 451 is sized to cover an inactive area 101b (shown in other figures) on a standard solar module 101, while large end cap 401 is sized to cover empty space created due to staggered positioning of rows of solar modules 101, as well as covering an inactive area 101b (not delineated here) which is part of a standard solar module 101. Also shown here are attachment flanges 401e and 451b to secure an inside lower end of each cover. In this embodiment, a screw or fastener is driven through a flange into a horizontal joint support between module rows. Note that in a solar array installation, an inactive area on a solar module could correspond to reference numeral 101b, shown in other figures.

FIG. 5I shows the roof assembly from FIG. 5H after large end caps 401 and small end caps 451 have been placed correctly. At their up-roof ends they are tucked below horizontal flashing 201, while at their down-roof ends they are above horizontal flashing 201. They are secured at their down-roof ends by fasteners through flanges 401e and 451b on a roof side, and to rake board 103 along their lower edges as needed. At their up-roof ends they can be fastened or held in place primarily by pressure from clamping of a down-roof edge of an up-roof module. For the large end caps 401, flange 401e isn't always needed if material underneath, such as vertical structural filler 404 from FIG. 3B, is adapted to accept fasteners from an adjacent near vertical surface at a lower end of large end cap 401. (Note that additional embodiments are contemplated where every row of modules is positioned all the way at a side edge of a roof, as opposed as the embodiment shown where some rows are offset and require different size end caps.)

FIG. 5J shows a closer view of a central section of the roof assembly where four solar modules meet. This drawing has the same components shown in FIGS. 5A-5I after all components have been installed. This view depicts clamps 204, which are positioned on hanger bolt 207 (shown in detail in other figures) and are adapted to secure modules in place. Each clamp 204 comprises an upper pressure pad 204a which presses down on an up-roof module, and a lower pressure pad 204b which presses on horizontal flashing 201, and thereby on a down-roof module which is partially under said horizontal flashing 201; each clamp 204 also comprises other components which secure the clamp to the roof assembly (shown in other figures in more detail). Additionally shown are vertical joint covers 301 and upper clamping washer 306, described in more detail in other illustrations.

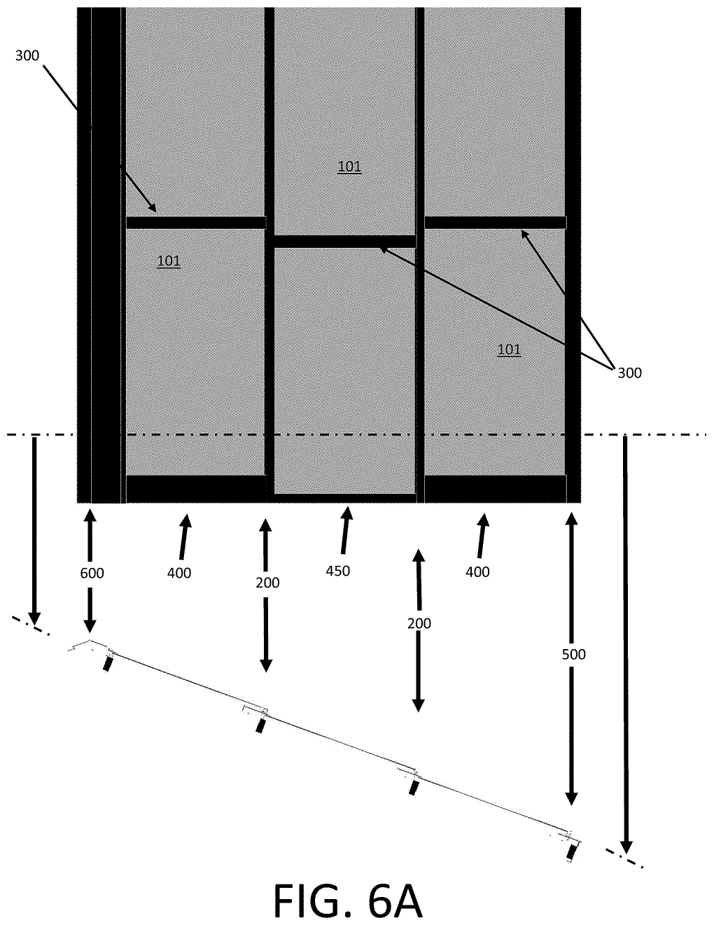

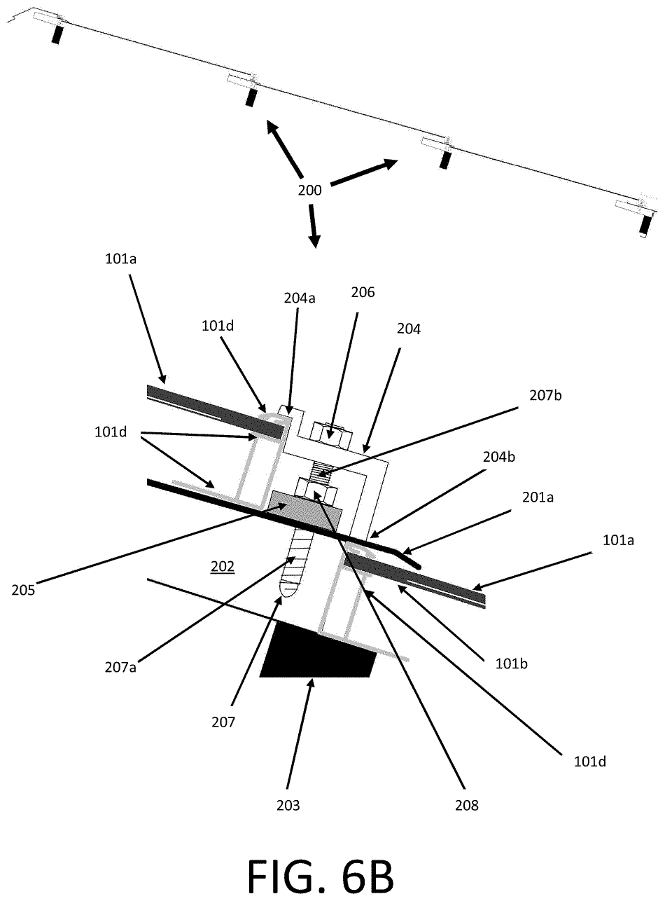

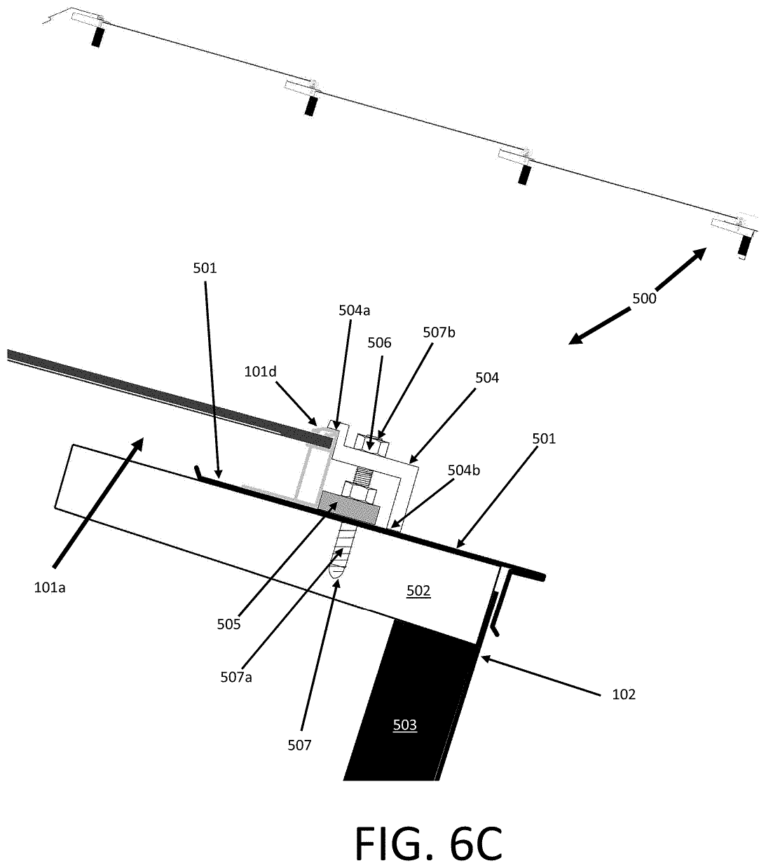

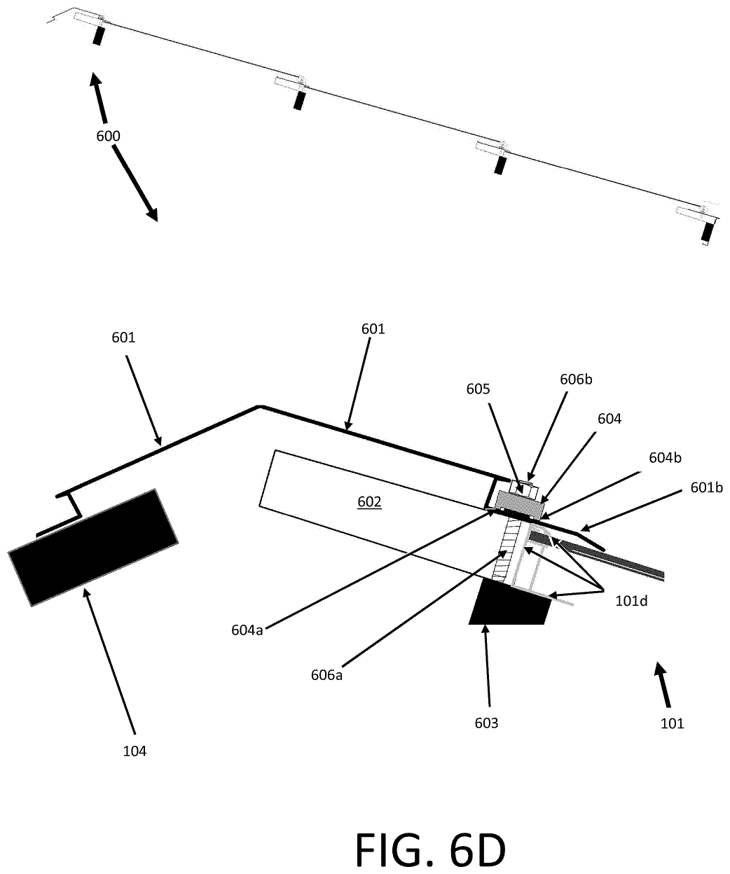

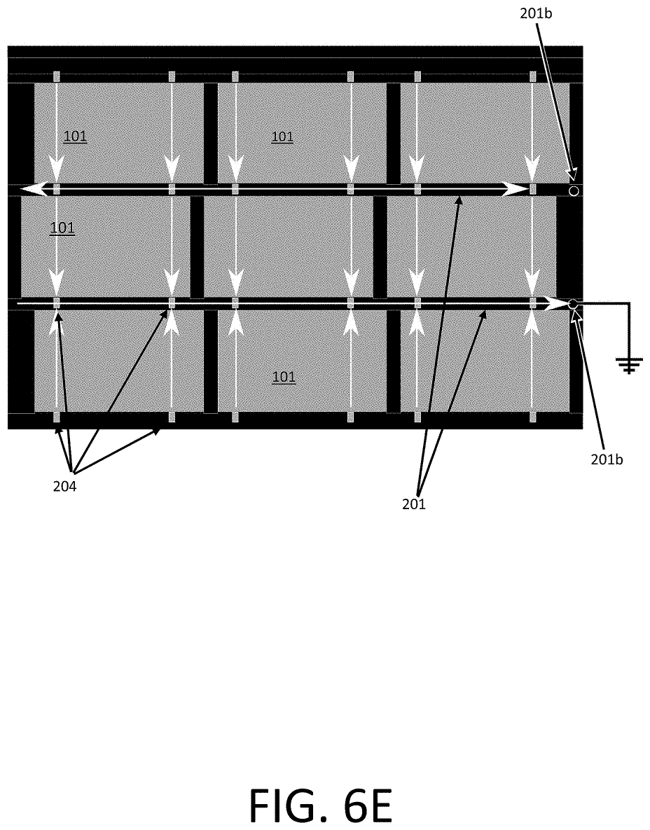

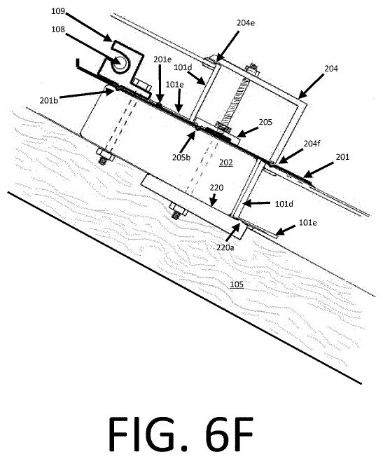

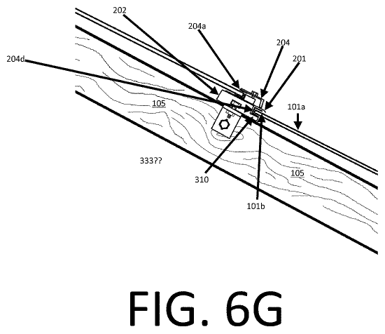

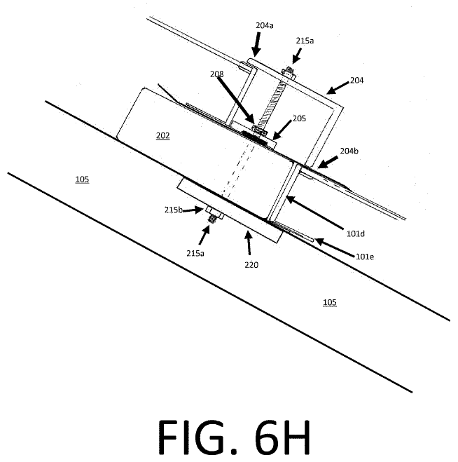

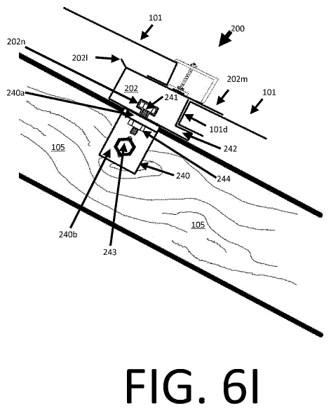

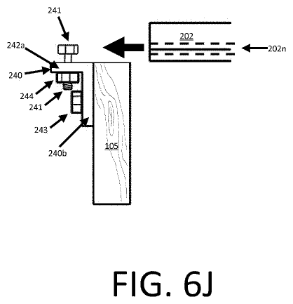

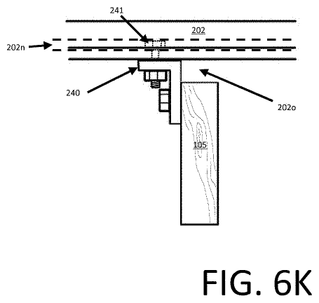

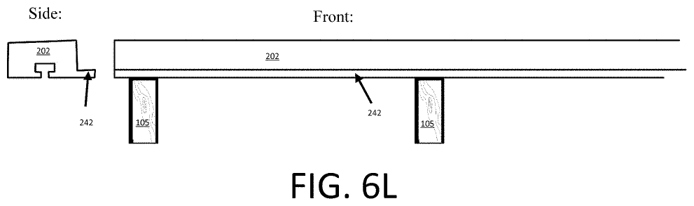

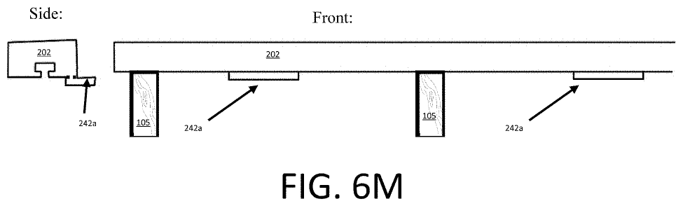

FIG. 6A shows a partial view of the roof from FIG. 2, but on this sheet the roof has been rotated 90 degrees counterclockwise. The dashed line denotes the location of a cross-section, moving from a horizontal peak assembly (top of the roof) on the left side of the sheet to a down-roof horizontal assembly 500 at the right side of the sheet. This figure also illustrates locations of two horizontal joint assemblies 200 in a central portion of the roof. The cross-section shown in the lower drawing and depicting the entire roof has critical areas detailed in FIG. 6B, FIG. 6C and FIG. 6D.

FIG. 6B is a standard species of horizontal joint assembly 200 in cross section. In this contemplated species, clamp nut 206 is driven downward creating pressure on clamp 204. This downward pressure is transferred to upper pressure pad 204a which presses directly on module frame 101d up-roof of the clamp nut 206, thus clamping that portion of up-roof solar module 101 and securing it in place. Lower pressure pad 204b down-roof of the nut presses on and slightly deforms (not necessarily beyond its elastic limit) horizontal flashing 201 until it meets and clamps upper frame 101d of a down-roof solar module. The result is, frame 101d of the down-roof solar module is clamped between lower pressure pad 204b and module up-roof support 203. Partially shown in this diagram is horizontal joint support 202 which provides structural support in a horizontal direction and is discussed further in future diagrams. Stanchion spacer plate 205 will also be discussed when other stanchion concepts are covered below.

FIG. 6C shows a cross section diagram of down-roof horizontal assembly 500, positioned at a bottom edge of a roof. The function of down-roof horizontal assembly 500 is to position and secure a bottom side of a lowest horizontal row of solar modules 101, provide weather proofing of that area of the assembly, and transition from roof surfaces to a vertical surface along an edge of the roof where down-roof horizontal cap 501 meets facia 102. In this contemplated species, clamp nut 506 is driven downward, creating pressure on clamp 504. This downward pressure is transferred to an upper pressure pad 504a which presses directly on module frame 101d in a position which is up-roof of clamp nut 506, thus clamping that portion of an up-roof solar module 101 and securing it in place against down-roof horizontal cap 501. A lower pressure pad 504b down-roof of the clamp nut 506 presses on down-roof horizontal cap 501 until it meets down-roof horizontal joint support 502. The result is module frame 101d is positioned and secured. Included in this diagram are down-roof purlin 503, stanchion spacer plate 505, and hanger bolt 507 with wood thread portion 507a.

FIG. 6D shows peak assembly 600 which is comprised of peak cover 601, which extends from a solar side of the roof on the right, across the peak, to the conventional roof 104 that would extend to the left of the peak. Weather such as sleet, rain, or snow which falls on the peak either flows from a left side of peak cover 601 onto conventional non-solar roof to the left, or onto solar module 101 on a right side, continuing downward on the solar side of the roof, comprised of the contemplated invention and modules 101 (not a part of the invention). A portion 601b extends over an inactive area 101b (disclosed in other figures) of module 101, whose upper portion is shown in this expanded assembly. Module frame 101d, making up a large portion of inactive area 101b, is clamped by ridge clamp 604. As in other areas of the contemplated invention, ridge clamp 604 presses through lower pressure pad 604b, securing module frame 101d between the clamp 604 and lower horizontal support 603. In this example ridge clamp 604 has a raised central portion and two pressure pads. Upper pressure pad 604a is located up-roof of clamping nut 605, while lower pressure pad 604b is down-roof from clamping nut 605. Lower pressure pad 604b aligns with the module frame 101d. When clamping nut 605 is driven downward, upper pressure pad 604a is held in place by peak cover 601 and peak horizontal joint support 602, while a lower portion of said clamping nut 605 would move downward towards and onto lower pressure pad 604b, which deforms slightly to press on and clamp module frame 101d. This figure also shows hanger bolt 606 with portions 606a and 606b.

FIG. 6E shows a ground path created by bonding components back to a wired connection point of horizontal flashing 201. Other solar racking systems use ground flashing, but don't use flashing as a return path. Electrical assemblies are made up of conductive material meant to conduct electricity, like copper in wires for example, and insulating materials meant to keep electricity only where it belongs, like glass on a solar module, or rubber or plastic insulation surrounding a wire. When there is a breach in an insulating material it is referred to as a “short circuit”, or a “short”, or a “ground fault” depending on what type of connection is made, and where in the circuit it happens. Conductive materials, like aluminum, that are not intended to conduct electricity as part of normal system operation, like an aluminum frame of a solar module, need to be “grounded” as is well known in the art. Generally any conductive material in contact with a solar module frame or wire, or in contact with another conductive material that is in contact with a solar module or frame, needs to be connected to an “earth ground”. This illustration shows a horizontal flashing 201 that is adapted to have a wired connection point 201b. A lower horizontal flashing 201 with connection point 201b connects to a symbol for earth ground, as might appear on a schematic diagram. An upper horizontal flashing 201 also has connection point 201b, but this point does not have a wired connection to earth ground. In this case, each piece of flashing has been manufactured to have the wired connection point 201b available, but because the horizontal flashing 201 and all of the conductive parts that contact them are adapted to be electrically bonded, as is well known in the art, only one wired connection is needed, having the advantage of not needing additional labor and materials to make additional wired connections. While other systems use flashing, and that flashing may be bonded to other major conductors for grounding purposes, said flashing is not the major return path, as is illustrated here. For example, if solar module 101 (hereinafter “module”) in the upper left of the array were to have a ground fault, that ground current would travel through the module's frame to the horizontal flashing 201, which is adapted to be electrically bonded to said frame, and current would travel through clamps 204 in contact with the faulty module, which are also bonded to the module frame, and closest to the wired connection point 201b below. Other module frames would act as conductors, being bonded to both horizontal flashings 201 as they and the clamps 204 are adapted to do said bonding. When current gets to the flashing with the wired connection, the lower horizontal flashing 201 and the wire connected to it will carry the fault current to the earth ground, as is well known in the art. Other system components outside the scope of the invention are designed to react to said faults and can react accordingly. This also keeps personnel safe as these bonded and wired fault current paths are of a lower resistance than the body of the personnel contacting them, making electricity more likely to travel through these more conductive materials than the body of the person. Note that clamping points are typically critical for good bonding as they represent a point of stable contact, but other means may be used to bond components to flashing. Bonds may exist that are not shown in this figure, and the means of bonding shown here do not limit the scope of this aspect of the invention.

FIG.6F shows a cross-sectional area of horizontal joint assembly 200 which depicts various grounding and bonding adaptations. As is well known in the art, “barbs” or other adaptations can pierce through an outer surface of paint or other conductivity inhibitors on surfaces of conductive materials. This establishes an electrical bond in order to promote conduction between adjacent conductive components. Shown in this figure are a grounding lug 109 at flashing grounding point 201b, a cross-section of equipment grounding conductor 108, and horizontal flashing 201. In this design, a bare wire component of equipment grounding conductor 108 is adapted to be electrically connected to the earth or to another electrical ground. Note that in some embodiments (not illustrated here), horizontal support 202 might be made of metal or another conductor and can assist in grounding of other components. Shown in this figure are points at which electrically conductive components contact each other in a manner that assists in an eventual connection to equipment grounding conductor 108 via horizontal flashing 201, including: flashing grounding point 201b, which links grounding lug 109 to horizontal flashing 201; up-roof support plat bonding barb 220a, which bonds up-roof support plate 220 to module frame lower flange 101e; stanchion spacer plate bonding barb 205b, which bonds stanchion spacer plate 205 to horizontal flashing 201; clamp to flashing bonding barb 204f, which links clamp 204 to horizontal flashing 201; and clamp to up-roof frame bonding barb 204e, which links clamp 204 to module frame 101d of an up-roof module. In this case, the up-roof module is bonded to horizontal flashing 201 through clamp 204 via barbs 204e and 204f at its upper and lower clamping surfaces. Electrical connections in this view can comprise components and adaptations known in the art, such as direct contact, physical conducting pieces, and/or deformed surfaces which guarantee an electrically bonded connection. Note that when the invention is implemented as an array with multiple solar modules, each module can be removed without interrupting electrical connections that other modules require for grounding.

FIG. 6G shows a horizontal joint assembly in cross section that is adapted to work with frameless modules rather than framed modules. This figure depicts an up-roof frameless module and a down-roof frameless module which comprises active area 101a and inactive area 101b, and also depicts rafter 105, horizontal flashing 201, horizontal joint support 202, clamp 204 with upper pressure pad 204a, frameless clamp cushion 204d, and up-roof frame support 310.

FIG. 6H shows a cross section of horizontal joint assembly 200 and clamp 204. This figure shows an alternative to module up-roof support 203, seen in other drawings. In this embodiment, up-roof support plate 220 is used in place of module up-roof support 203. An up-roof end of module frame 101d is supported by said up-roof support plate 220 which is held tightly to horizontal joint support 202 by lower nut 215b, which clamps said plate in concert with stanchion plate nut 208. Both nuts are on threaded rod 215a, which passes through horizontal support 202. Because clamp 204 puts a great deal of pressure on module frame 101d in a downward direction, it could distort or bend solar module 101 if not supported. Up-roof support plate 220 is adapted to not cover much of module frame lower flange 101e, which leaves it available for electronics equipment that is often mounted there, such as “dc optimizers” or micro-inverters, as are commonly known in the art.

FIG. 6I shows an alternative shape for horizontal joint support 202 and surrounding parts, some previously seen and some new. As contemplated here, horizontal joint support 202 would be a single extruded part replacing many individual parts in previously contemplated horizontal joint assembly 200. Up-roof frame support flanges 242 are used to support metal frames 101d of solar modules 101 in embodiments where metal-framed modules are used. (Note that frameless solar modules are also contemplated and are disclosed elsewhere in this application, such as in FIG. 6G.) Each rigid tapered up-roof frame support flange 242 functions as, and replaces, module up-roof support 203 and/or support plate 220, as used in other contemplated assemblies. Said frame support flanges 242 help prevent adjacent module frames from bending when they get downward pressure from clamp components of the invention. In this embodiment, horizontal joint support 202 is adapted to have catchment flange 2021, which replaces functionality of catchment flange 201a in other iterations (catchment flange 201a is typically a part of horizontal flashing 201, and is not used in this iteration). Further, inactive portion 101b of solar module 101 (normally covered from above by horizontal flashing 201) is covered by flange 202m in this iteration, which is another adaptation of horizontal joint support 202. FIG. 6I shows an alternative method of attachment between horizontal joint support 202 and rafter 105. Components can be secured to rafters 105 via “L” bracket 240, having a horizontal side 240a and a vertical side 240b. In this and further illustrations, one can see a head of a lag bolt 243 securing vertical side 240b to rafter 105, while horizontal side 240a secures horizontal support 202 by using machine bolt 241 and nut 244. Horizontal support 202 is adapted to accept a head of bolt 241 in slot 202n, which runs completely through horizontal support 202 from end to end. This is seen in additional drawings below.

FIG. 6J shows a rotated cross-sectional view of the alternative embodiment from FIG. 6I. This view indicates how the L-shaped bracket 240 and a head component of bolt 241 from FIG. 6I operate to secure horizontal joint support 202 in place. In this view, the L-shaped bracket 240 comprises a vertical part 240b, which is secured to rafter 105 (viewed here from its narrow end) by using lag bolt 243. This view shows horizontal joint support 202 in position to slide leftward into place around the head of bolt 241 as is shown in FIG. 6I and later in FIG. 6K. As is seen in the cross-sectional drawing in FIG. 6I, horizontal joint support 202 is adapted with mounting slot 202n at its lower side to accept the head of bolt 241. Said slot 202n is indicated here by dotted lines on horizontal joint support 202.

FIG. 6K shows a rotated cross-sectional view of L-shaped bracket 240 and horizontal joint support 202, after horizontal joint support 202 has been slid into position to cover and surround a head component of bolt 241. In this illustration bolt 241 is ready to be tightened, securing horizontal support 202 in position. FIG. 6K also presents a teaching not shown elsewhere in this series of illustrations. In this drawing, L-shaped bracket 240 has been moved to a higher position relative to rafter 105 in order to create a gap 202o between horizontal support 202 and rafter 105. When installing, roofing system wires will often run horizontally along rows of solar modules from one module to the next. In cases where a vertical joint of a row lands on or close to rafter 105, passage of wires might be blocked, and said wires would then have to be run under rafter 105. With gap 202o, though, a wire can be passed above rafter 105 rather than below. This might reduce the need to provide special protection for said wire, since going below deviates from solar wiring techniques that are well known in the arts, such as clipping or tying wire to frames of the modules, which are grounded and non-combustible, which is not true of rafter 105 as shown here. Note that although this concept is not shown in drawings showing horizontal joint assemblies, the same gap can be achieved by raising horizontal support 202 and module up-roof support 203 relative to rafter 105, thereby allowing passage of wire secured along horizontal frames of the solar modules.

FIG. 6L shows a design for horizontal joint support 202 from FIGS. 6I-6K (seen in both a side view and a front view), wherein up-roof frame support flange 242 runs full-length along horizontal joint support 202.

FIG. 6M shows an alternative design for horizontal joint support 202, in which there are multiple noncontiguous up-roof frame supports 242a. With this design, up-roof frame supports 242a can be spaced in a way that causes them to be positioned between rafters 105. Note also that noncontiguous up-roof frame supports 242a can extend further downward than top surfaces of rafters 105 if a lower profile on the roof is desired. Some material savings may also be realized.

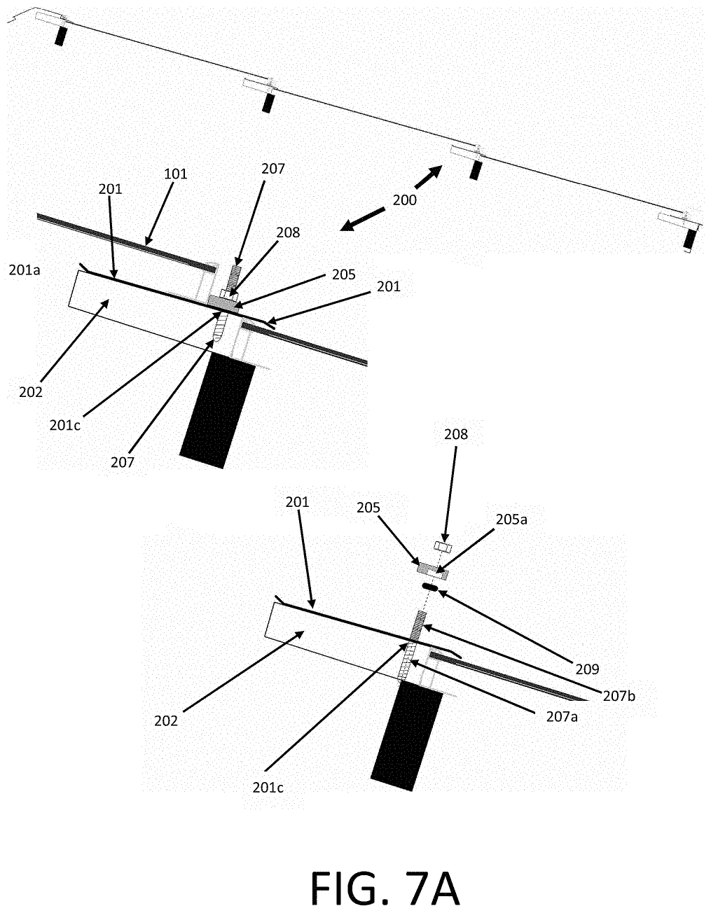

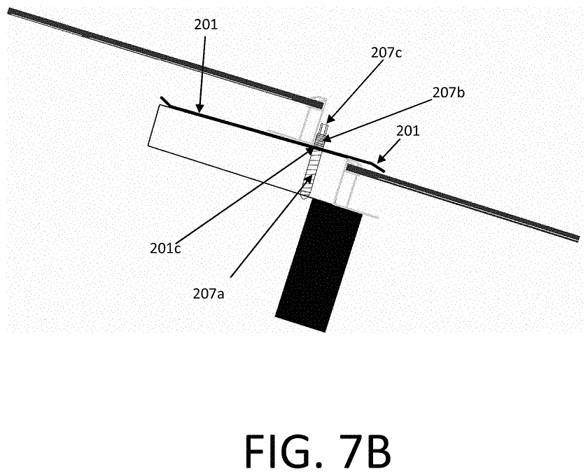

FIG. 7A shows a module clamping sub-assembly referred to as a stanchion. The stanchion is typically a rigid assembly that can prevent solar modules from sliding down the roof while they are waiting to be installed, or affixed in place, as in the process described in the discussion of FIG. 5 above. The stanchions as shown in FIG. 7A also provide a means of tightening clamps 204 shown in other figures. In these examples, the stanchions are comprised in part by various types of hanger bolts 207, as are widely known in the art, driven into a wooden horizontal joint support 202. Portion 207a of hanger bolt 207 has threads appropriate for wood, while top hanger bolt portion 207b has machine threads to accept stanchion plate nut 208 and clamp nut 206. For the hanger bolt 207, stanchion plate nut 208 is used to drive the hanger bolt 207 into wooden horizontal joint support 202. The upper drawing shows an up-roof solar module 101 frame resting against stanchion plate 205, while in a lower drawing this module is not shown.

FIG. 7A also shows a stanchion fully assembled in its upper drawing, while the lower drawing shows components in an exploded version to illustrate a waterproofing technique widely known in the art as applied to the invention. In this exploded illustration, stanchion's spacer plate 205 is shown in cross section to illustrate cavity 205a. Spacer plate 205 has a slightly smaller inside diameter than an outside diameter of “O” ring 209, which becomes compressed into cavity 205a as spacer plate 205 and horizontal flashing 201 come together. As O-ring 209 is compressed within cavity 205a, it creates an effective seal for penetration 201c, which is where horizontal flashing 201 would otherwise be vulnerable to leaking. Note that the invention is not limited to a hanger-bolt based stanchion. Note also that in this illustration, 209 is an O-ring, but the invention is not limited to this geometry. Any parts around penetration 201c may take many shapes known in the art to achieve weatherproofing and other characteristics. Also shown in FIG. 7A is horizontal flashing 201, with catchment flange 201a shown on the left side of the upper drawing. The purpose of the catchment flange 201a is to prevent any fluid that may infiltrate from an up-roof direction from dropping below the horizontal flashing 201. Because framed modules are not manufactured with waterproofing in mind, it is also possible for fluid to enter between a module frame and module glass. Were that to happen, fluid could rest on the horizontal flashing 201 until it evaporates. The catchment flange 201a ensures moisture won't fill space above the horizontal flashing and drip over its edge into space below.

In FIG. 7B, hanger bolt 207 is driven via hex portion 207c since the hanger bolt 207 stands alone as the stanchion without stanchion plate nut 208 for installation. This simplified stanchion is used for alternative clamps shown in other figures.

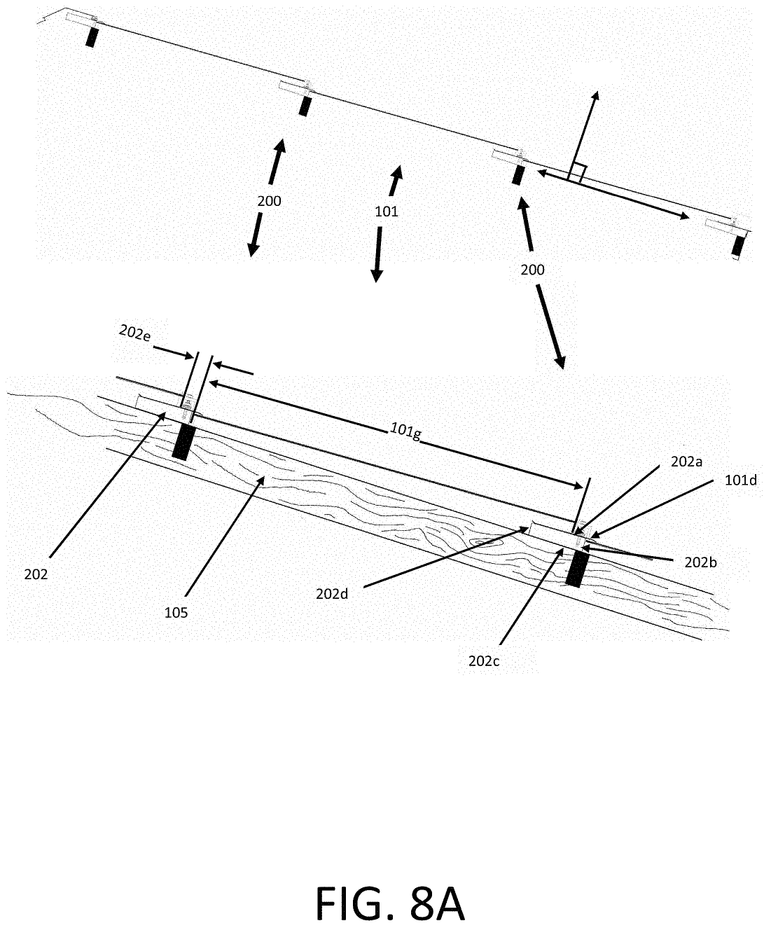

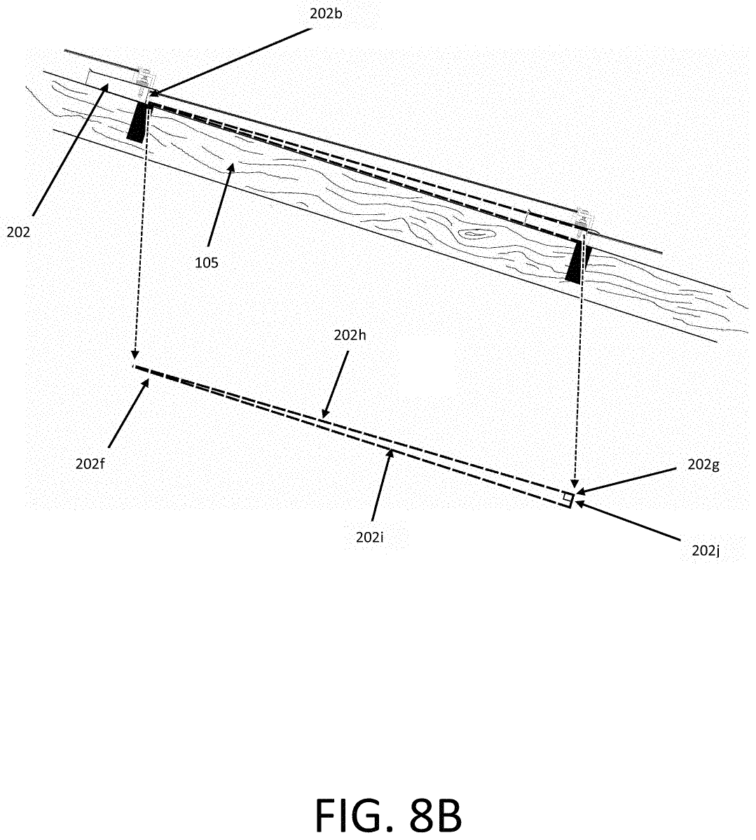

FIGS. 8A and 8B illustrate factors that result in a tapered configuration of horizontal joint supports 202. Note that although only horizontal joint support 202 is shown in FIGS. 8A and 8B, similar features may be found in down-roof horizontal joint support 502 and/or peak horizontal joint support 602 (shown in other figures).

(Wooden vertical framing member 105, known in the art as a “rafter” or a “top chord” of a wooden truss, may be added to represent an angle of a conventional roof structure depicted here. The terms board, rafter, top chord, and wooden vertical framing member are used interchangeably here.)

FIG. 8A includes a top drawing which depicts a side cross-sectional view of a roof, showing wooden vertical framing member 105, solar module 101, and horizontal joint assemblies 200. This top drawing also shows right-angled arrows pointing in directions parallel to, and perpendicular to, board 105. This figure also includes a bottom drawing, illustrating features of the invention which hold solar module 101 at a specific angle relative to rafter 105. This bottom drawing shows horizontal joint support 202 with sides 202a, 202b, 202c, and 202d. Side 202a (a top, skyward side) and side 202c (a bottom side) are oriented at a particular angle relative to one another, because of horizontal joint support 202 having a tapered shape. In this example, the relative angle of sides 202a and 202c is what is being illustrated. Side 202c rests on a top surface of rafter 105, and therefore has the same orientation. Note that it is the angle of side 202a to the conventional roof angle of board 105 that is critical—because of it, horizontal joint support 202 holds solar module 101 in a particular orientation relative to board/rafter 105. Achieving a same or similar angle by other means is included within the invention; in other words, embodiments which hold solar module 101 at a desired orientation and angle relative to board 105 are contemplated, even if such embodiments achieve this aim with different features—such as rotating a non-tapered horizontal beam and using it to support solar module 101 at a particular angle, rather than using a tapered horizontal joint support 202. Moreover, relative angles different from the specific one shown in these drawings are also contemplated. Note that in this embodiment, side 202d (up-roof) is shorter than side 202b (down-roof). With framed modules such as the ones used in this figure, the height of module frame 101d will be roughly equal to the height of side 202b (where “height” refers to a measurement perpendicular to the top surface of rafter 105).

(Note: the two critical horizontal dimensions are the overall horizontal dimension of the module 101g as shown, and spacing 202e between horizontal rows of modules—these are shown in other figures.)

FIG. 8B illustrates a relative angle 202f between orientations of rafter 105 and solar module 101. This relative angle 202f is crucially relevant in cases where a horizontal joint support 200 with a specific tapered shape rests atop a roof's board 105 (and/or a substructure of a roof line). In a top drawing, there is a dashed-line triangle superimposed on the assembly, then replicated below for simplicity. Angle 202f is sought by calculation. Angle 202g is a right-angle formed by sides 202j and 202h. Side 202j is roughly equal in dimension to the height of module frame 101d (“height” measured perpendicular to rafter 105). Side 202h is equal to the combination of length 101g (see previous, FIG. 8A) of solar module 101, plus spacing 202e (also seen in FIG. 8A) to another module down-roof. The dimension of hypotenuse 202i is not needed here. In cases where two sides are known and the angle is sought, the inverse trigonometric function arc tangent is used. (Arc tangent of dimension 202j divided by side 202h will yield the value for angle 202f) To plug in numbers for an imaginary installation of this type, we can use modules with a dimension of 39.5″ and an imaginary spacing of 1.5″ and a frame height of 1.375″. To calculate side 202h we add 39.5″ and 1.5″ spacing for a total length of 41″. If we divide the module height 1.375″ in this example by 41″ we get 0.0334. Using this value, the arc tangent results in an angle of 1.92 degrees. Therefore, in this case, side 202a (of horizontal joint support 202) is at 1.92 degrees to the substructure of the roof line. As is evident from this calculation, changing the module dimension, or spacing between rows, or module frame thickness, will result in a different angle. Recall from earlier illustrations that spacing 202e can change to adjust the overall roof size which makes 202h a variable, unlike the vast majority of BIPV solar roofs which do not allow for adjustment of spacing between modules. Because we are using a variety of off-the-shelf modules, our module dimension can change from one manufacturer to another, also different from BIPV systems where special modules are manufactured. (That is, the invention has adjustable elements which allow it to be used with various sizes of solar modules. By contrast, a typical BIPV system requires modules of specific sizes to be specially manufactured to fit the system.) An even greater difference is realized when a roof is made up of modules in “portrait mode” (with modules oriented so that their up-and-down-roof dimensions are larger than their horizontal, across-roof dimensions) rather than “landscape mode” (as has been the case for all previous illustrations). In the case of portrait mode, a long dimension of the module goes in a vertical direction, meaning up- and down-roof. In the example above, the dimension of 39.5 inches would instead be on the order of 66 or 79 inches. The conceived invention accommodates many options for roof size, and many sizes of off-the-shelf solar modules. (Module thickness can vary greatly from one manufacturer to another, for instance.) By contrast, typical building integrated systems with custom modules don't possess any flexibility to vary overall roof dimensions (other than adding or subtracting a row or column of modules, and making up the difference with by using conventional roofing surrounding the solar array).

Also for instance, a user might prefer frameless modules instead of framed ones. A frameless module, whose thickness is determined by just two layers of glass without a frame, results in a different 202f angle and the formula results in a very different angle.

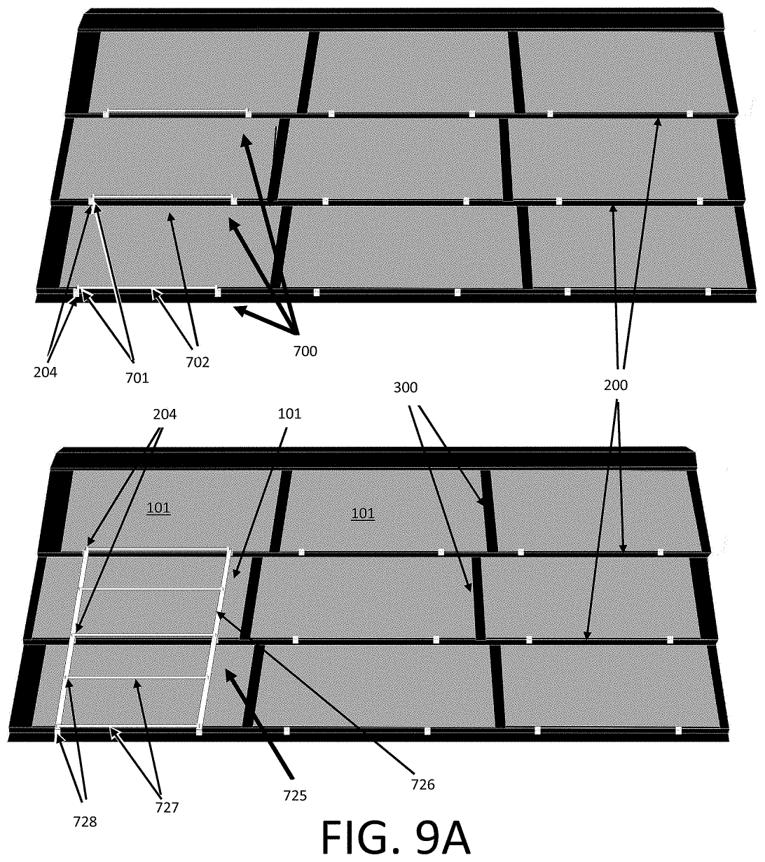

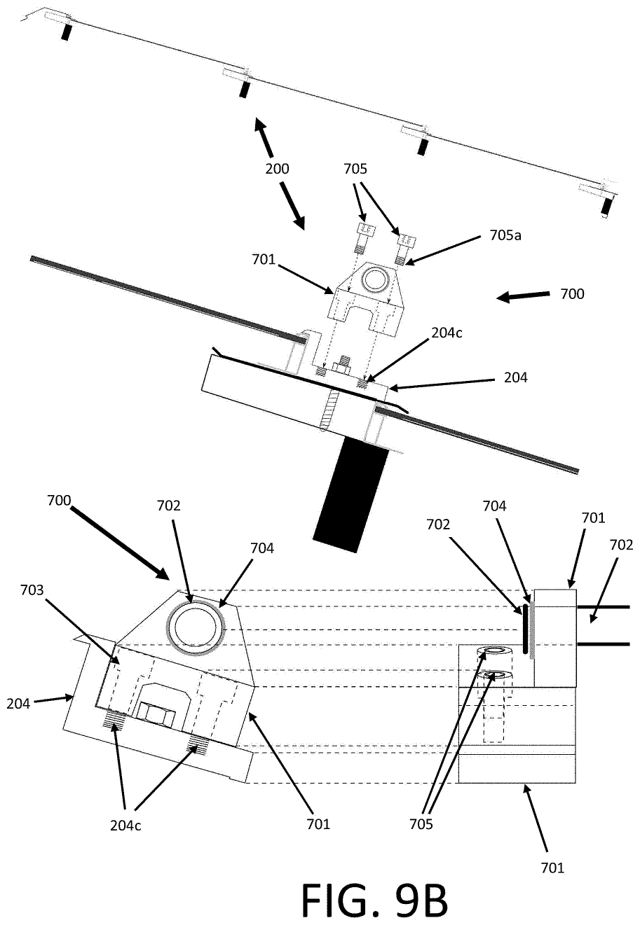

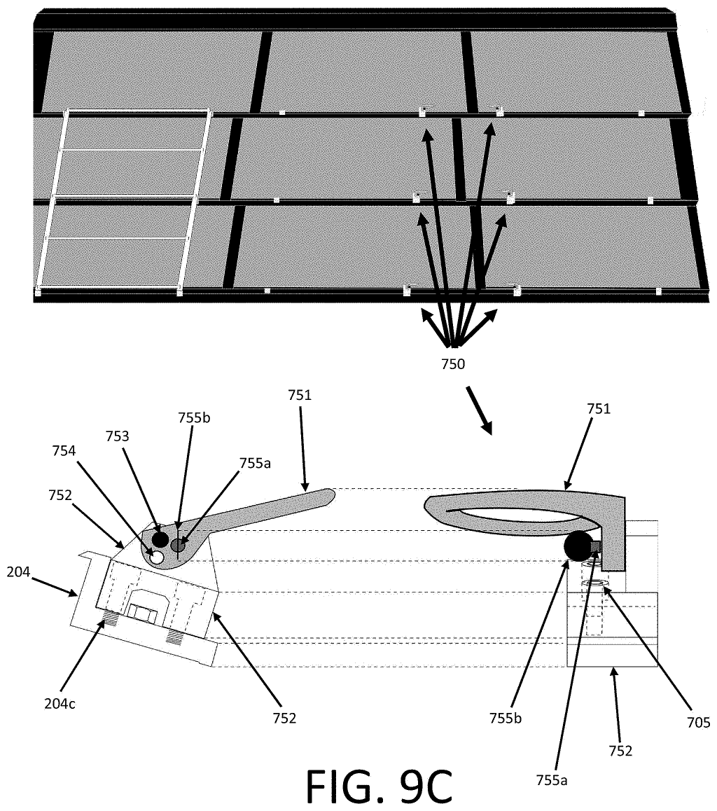

FIG. 9A shows two perspective drawings of two solar roofs which include climbing apparatuses. An upper drawing has three clamp rung assemblies 700 installed on a left-most column of solar modules. A lower drawing shows clamp ladder 725, installed on a left-most column of solar modules 101. In the upper drawing, as described in more detail below, clamp rung-block 701 is bolted onto clamps 204. Rungs 702 are the portion of the rung assembly 700 which would be used to grab with hands and stand on with feet in order to climb the solar roof. In the lower drawing, ladder clamp block 728 is bolted onto clamps 204. Rungs 727 are the portion of the clamp ladder 725 which would be used to grab with hands and stand on with feet in order to climb the solar roof. Unlike clamp rung assembly 700, clamp ladder 725 provides additional rungs between the horizontal joint assemblies 200 (in this figure, these additional rungs are the clamp ladder's second and fourth rungs). In order to do so, ladder side rail 726 is suspended on top of and attached to ladder clamp block 728. In this species, ladder rung 727 could be attached to and supported by ladder side rail 726. Ladder clamp blocks 728 at horizontal joint locations are attached to and supported by clamps 204. In this species the clamp ladder 725 is shown supported by clamps 204, but this does not limit the invention. In other embodiments, attaching clamp ladder 725 more directly to other components such as horizontal joint assembly 200 might be contemplated. Also, in this figure both the clamp ladder 725 and clamp rung assembly 700 are shown directly over a single column of solar modules 101; however, alternate embodiments are also contemplated which might include clamp ladders or clamp rung assemblies of different sizes, and/or secured in different positions using different clamps on a roof. One example might include a horizontally smaller clamp ladder, attached to clamps adjacent to borders of solar modules 101, and/or adjacent to vertical joint assemblies 300, and therefore positioned over said borders and vertical joint assemblies. (Smaller horizontal dimensions would require less material to achieve the same strength of a given rung.)

FIG. 9B shows expanded views of one embodiment of clamp rung assembly 700. In these drawings clamp rung-block 701 is shown being bolted to clamp 204. Socket-head cap screw 705 is put through countersunk clearance holes 703 (see lower left drawing). Male threads 705a of the socket-head cap screw 705 mate with female threads 204c in order to support and attach assembly 700 to the roof. In the lower drawings, assembly 700 shows rung 702 as a round rod coming through a top part of clamp rung-block 701 and being attached to it via weld ring 704.

FIG. 9C illustrates a climbing apparatus that does not use rungs to support the climber, but rather clamp grab-step assemblies 750 for a single hand or foot rather than multiple appendages. The upper drawing shows a perspective view of a solar roof comprised of a three by three solar array. This drawing includes a possible configuration for grab step assemblies 750, attached to clamps 204 on a roof in two vertical rows. Lower drawings in FIG. 9C illustrate clamp grab steps in more detail. The side-view on the lower left shows grab step 751 attached to grab-step block 752 with pivot pin 753. In this species, grab step 751 is able to adapt to different roof angles, or to be stored at a different angle if this is advantageous for solar access when not being used (otherwise, it may cast a shadow on modules 101). To change orientation of grab step 715, locating pin handle 755b would be grabbed in order to remove pin portion 755a from a hole (not shown) in grab-step block 752. With locating pin 755 removed, grab step 751 can be rotated around an axis formed by pivot pin 753 until clearance hole 754 is aligned with a selected hole in block 752. Locating pin 755 is put through clearance hole 754 and into the selected hole in block 752, thereby holding grab-step 751 at a different angle. While in this illustration two rotational positions are shown as possible options, other methods of securing, rotating, and positioning widely known in the art are also contemplated.

Any of these assemblies shown in FIGS. 9A through 9C can be broken into sections that can be built from the bottom up, top down, or from the end of the roof inward. This will enhance usefulness in cases where said assemblies are not a permanent installation at a given site. For service in a multi-story building, a technician could install a lower section from a standard ladder, then stand on this section to install another section, and work their way up the roof to a desired height or horizontal row required to best perform the services needed.

Note that attachment by any method widely known in the arts is included here. Clamp 204 could have any number of adaptations to accept and secure any portion of the climbing apparatus conceptualized, as could other locations or instances of horizontal joint assembly 200, vertical joint assembly 300, as well as adaptations on end cap assemblies 400 and 450. Peak assembly 600, and down-roof horizontal assembly 500 could also have any number of adaptations to support and secure a climbing apparatus. The embodiments shown here are all rigid assemblies, but adaptations are conceptualized where the assemblies can be folded up or down, either to enhance climbing ease for a given situation, or for storage.

While it doesn't matter for temporary service installations of any of the climbing apparatuses, those that may be permanently installed may be constructed of reflective material, have separate reflectors mounted to them, or be made in a geometry to help mitigate losses of energy production due to shading of active area 101a of solar modules 101 in proximity to the climbing apparatus. Note that these components can change based on geographic location of installation, where weather patterns and angle of incidence to the sun can be taken into consideration, as well as slope of the solar roof.

Grab steps or handles can function as steps, footholds and/or handholds when a homeowner, technician, firefighter, first responder, or other person needs to move from place to place on a roof assembly. Note also that embodiments are contemplated where grab steps or handles can be reversibly attached to other roof assembly components. Note that rotating is illustrated, but twisting on a different axis or other methods of folding are also contemplated. Rotational and/or folding functionality of a grab step or handle can be useful for a number of reasons, such as conveniently placing them out of the way into a configuration which does not block sunlight from reaching solar cells of roof modules.

What is claimed is:

1. An apparatus comprising a rigid or semi-rigid clamp adapted to secure adjacent up-roof and down-roof modules atop one or more supporting substructures, said clamp being comprised of an upper clamping surface, a central portion, and a lower clamping surface, wherein the upper clamping surface and lower clamping surface have a height differential along an axis which is perpendicular said supporting substructure, and wherein said upper clamping surface is positioned above a down-roof section of the up-roof module, and wherein said lower clamping surface is positioned above an up-roof section of a down-roof module, and wherein said clamp is adapted to be moved downward and adapted to put simultaneous downward pressure on said up-roof and down-roof modules.

2. The apparatus as in claim 1, comprising a covering along an edge of a solar module, including “off-the-shelf” solar modules, wherein said covering extends over the module frame, where present, and beyond, to cover some portion of, or the entire inactive area of the module, up to the active area (the cells or other energy conversion surface) along that edge of the module.

3. The apparatus as in claim 2 wherein a vertical joint assembly comprises an upper cover, wherein said cover is positioned and sized appropriately to cover all or part of an inactive area of a first module, an adjacent gap, and all or part of an inactive area of an adjacent module.

4. The apparatus as in claim 3 comprising one or more end caps which are sized and positioned to cover some portion of, or an entire, inactive area of an adjacent side of an adjacent solar module, wherein said one or more end caps are also sized and positioned to extend in an opposite direction and to terminate at a boundary which matches an end boundary position of additional up-roof and/or down-roof end caps.

5. The apparatus as in claim 4, wherein said one or more end cap extend(s) downward along a rake of a roof, or a horizontal wall, or other adjacent vertical building cladding or structure.

6. The apparatus as in claim 5 wherein horizontal flashing is partially positioned below a down-roof horizontal edge of an up-roof solar module or modules, and also extends above and/or atop an inactive area of an upper edge (to be consistent with the beginning of the sentence) of a down-roof solar module or a plurality of solar modules.

7. The apparatus as in claim 6 wherein said vertical joint cover is adapted dimensionally to work in concert with “off-the-shelf” solar modules, being of various and differing lengths from various manufacturers, to achieve a desired overall horizontal dimension for the horizontal row in which it or they are a part

8. The apparatus as in claim 7 comprising a vertical joint assembly positioned in a gap between two modules in a horizontal row, comprising a vertical joint cover on a skyward side, a gutter below said gap , and a horizontal module spacer in said gap.

9. The apparatus as in claim 8 wherein an end cap is adapted and shaped to extend under horizontal flashing at an up-roof end of said end cap, and is additionally adapted and shaped to extend down-roof.

10. The apparatus as in claim 9 wherein said end cap is adapted and shaped to extend over a down-roof edge of a module, fully or partially, and may be secured at a lower end of said end cap to other invention components at that lower end.

11. The apparatus as in claim 10 wherein said horizontal flashing is adapted to act as a primary return path for fault currents, and is adapted to carry said fault currents to a wired connection elsewhere on said flashing.

12. The apparatus as in claim 11 solar mounting component or covering that is adapted to receive, work in concert with, or adapted to be a climbing apparatus, such as rungs, hand/foot holds, interspersed within the array boundary and/or at an array boundary.

13. The apparatus as in claim 12 wherein said rungs, and/foot holds are suspended above a solar module or modules. (this further separates it from one other patent in prior art)

14. The apparatus as in claim 6 wherein said horizontal flashing is adapted dimensionally to work in concert with “off-the-shelf” solar modules, being of various and differing dimensions from various manufacturers, to achieve a desired overall vertical dimension for the horizontal row(s) in which it or they are a part.

15. The apparatus as in claiml4, further comprising a horizontal support along a down-roof side of a horizontal row of modules, wherein a surface of said horizontal support that supports the down-roof edge (or side) of the up-roof module forms an angle with a supporting substructure structure whose arc tangent is equal to a ratio found when dividing module height (measured in a direction perpendicular to a supporting substructure) by the combined length of a row of modules and an adjacent gap (measured in a “vertical”, meaning up-roof/down-roof, direction).

16. The apparatus as in claim 15, further comprising a gutter as in claim 15 wherein said gutter extends horizontally beyond frame elements of adjacent modules, with an up-turned flange positioned beyond a frame element, with said gutter and flange extending at a lower end beyond an up-roof flange of a waterproof membrane below.

17. The apparatus as in claim 16, wherein a down-roof horizontal edge of said horizontal flashing extends beyond an upper end of any vertical joint cover and/or end caps.

18. The apparatus as in claim 17, further comprising a module up-roof support, sized and positioned to support some portion, but not all of the bottom side of the up roof edge of said module, wherein said support is sized and positions so as to leave a portion of the lower module frame flange accessible for mounting electronic equipment, such as, but not limited to, micro-inverters, DC optimizers, rapid shutdown components, or grounding connections.

19. The apparatus as in claim 18, wherein said clamp or clamps are positioned so that the clamping location on the up-roof module, and the location on the down-roof module, which would be different due to row offset, both fall within the allowable clamping location (“window”) of an off-the-shelf solar module, as specified by the manufacturer.

20. The apparatus as in claim19, further comprising a horizontal peak cap as in claim 3, wherein one edge of said horizontal peak cap is positioned over a conventional roof along one edge, and extends in a down-roof direction to cover an up-roof edge of an uppermost horizontal row of solar modules, and covers all, or some, portion of an inactive area of said uppermost horizontal row of solar modules.

21. The apparatus as in claim 1, wherein the lower clamping surface of said clamp is positioned atop a waterproof membrane which is positioned atop an up-roof section of a down-roof module, and is adapted to apply pressure on said waterproof membrane, and through said waterproof membrane onto said up-roof section of said down-roof module.
